(19) United States
(12) Patent Application Publication
(10) Pub. No.: US 2021/0312531 A1
(43) Pub. Date: Oct. 7, 2021

(54) SYSTEMS AND METHODS FOR DISPLAYING GLOBAL PRODUCT DATA

(71) Applicant: SHOPIFY INC., Ottawa (CA)

(72) Inventors: JESSE MCGINNIS, WATERLOO (CA); BENJAMIN CHARLES KIRKHAM MORRIS, WATERLOO (CA); JOVANA MANDIC, TORONTO (CA); MICHAEL KOVACEVIC, KITCHENER (CA)

(21) Appl. No.: 16/841,912

(22) Filed: Apr. 7, 2020

(51) Int. Cl. G06Q 30/06; G06Q 10/08

(52) U.S. Cl. CPC G06Q 30/0641; G06Q 10/087; G06Q 30/0623; G06Q 30/0633

(57) ABSTRACT

A merchant may use a commerce platform to sell products. The merchant may manage multiple stores on the platform, e.g. a U.S. store and a Canada store. Each store managed by a same merchant sells a respective catalog of products. A particular product may be offered for sale by the same merchant across multiple stores. In some embodiments, there is provided a computer-implemented system and method that allows the merchant to view, through a user interface on a merchant device, the global collection of products offered for sale by the merchant across all the merchant's stores.

### FIELD

The present application relates to organizing global product data in memory, and displaying the global product data on a merchant user interface.

### BACKGROUND

A merchant may use a commerce platform to sell products to customers. The commerce platform will be referred to herein as an e-commerce platform. The products for sale by the merchant may be sold online via one or more online stores. A merchant may manage multiple stores, each with its own separate inventory, orders, domain name (or subdomain), currency, etc. For example, the merchant may manage three online stores: yogamat.com, which is their main U.S./global store, ca.yogamat.com, which is their Canada-specific store, and fr.yogamat.com, which is their France-specific store. The three stores are all associated with the merchant's account. The merchant configures each store to correspond to a different country of business.

Each store associated with a same merchant account sells a respective catalog of products. Each product has a set of attributes that are stored in the e-commerce platform in relation to the product. Examples of attributes include title of the product, color of the product, description of the product, number of units in stock (inventory), price of the product, etc.

A particular product may be offered for sale by the same merchant on multiple stores. However, each store has its own set of attributes stored in relation to the particular product, even if some of those attributes are the same across multiple stores. This allows the merchant to have attributes customized to each store. For example, the price of the particular product in the U.S. store may be $12.99 USD, but the price of the particular product in the France store may be $10 EUR.

In some cases, each store may be separately managed online by the merchant using login information particular to that store. The merchant may switch between stores by logging out of one store account and logging into another store account. When logged into a particular store account, the merchant can only view the products sold in that store and the associated attributes of those products, which are specific to that store.

### SUMMARY

When a same merchant manages multiple stores, the following problems may occur. If the merchant wishes to view online the global collection of products offered for sale by the merchant across all the merchant's stores, the merchant may need to separately log in to or enter the configuration settings of each particular store managed by the merchant. A same product sold across multiple stores will appear separately in each store in which the product is sold. Moreover, if that same product is to have a common attribute modified (e.g. if the product colour description is to be changed from “light yellow” to “cream”), then the merchant must use their user interface to separately enter the configuration settings of each store, search to determine if the product is sold in that store, and assuming so then manually make the change. This manual process must be repeated for each store.

It is desired to have a computer-implemented system and method that allows the merchant to view, through a user interface on a merchant device, the global collection of products offered for sale by the merchant across all the merchant's stores.

In some embodiments, a product matching algorithm is implemented that traverses each of the merchant's catalogs of each of the merchant's stores to identify a same product across two or more stores. In some embodiments, a global data model stores an indication of same products, along with an indication of which attributes of that same product are the same and/or different across the different stores in which that same product is offered for sale. In some embodiments, the information in the global data model may be used to present, on a display of the merchant device, a collapsed or partially collapsed view of attributes of a product that is sold across multiple stores associated with that merchant.

In one embodiment, a computer-implemented includes, for each store of a plurality of stores associated with a merchant account: storing an indication of each product for sale in the store, and for each product storing respective information describing attributes of the product. The method may further include determining that a first product in one of the plurality of stores and a second product in another of the plurality of stores are a same product. The method may further include comparing a first attribute of the first product to a corresponding second attribute of the second product and determining that the first attribute equals the second attribute. The method may further include comparing a third attribute of the first product to a corresponding fourth attribute of the second product and determining that the third attribute does not equal the fourth attribute. The method may further include transmitting, to a merchant device for display on the merchant device: (i) either the first attribute or the second attribute; and (ii) at least one of the third attribute and the fourth attribute. A system is also disclosed that is configured to perform the methods disclosed herein. For example, the system may include a memory to store information and at least one processor to directly perform (or instruct the system to perform) the method steps.

### BRIEF DESCRIPTION OF THE DRAWINGS

Embodiments will be described, by way of example only, with reference to the accompanying figures wherein:

FIG. 1 is a block diagram of an e-commerce platform, according to one embodiment;

FIG. 2 is an example of a home page of an administrator, according to one embodiment;

FIG. 3 illustrates the e-commerce platform of FIG. 1, but with a memory to store a global data model, and a processor that generates and maintains the global data model;

FIG. 4 illustrates a system for implementing store-level and global-level data models for merchants selling products on an e-commerce platform, according to one embodiment;

FIG. 5 illustrates example store-level product data for one merchant on the e-commerce platform;

FIGS. 6 and 7 illustrate example product webpages;

FIGS. 8 to 10 illustrate example merchant interface webpages for viewing product data at the store level;

FIGS. 11 to 13 illustrates example global data models for one merchant;

FIGS. 14 to 18 illustrate example merchant interface webpages for viewing product data at the global level;

FIG. 19 illustrates steps of a computer-implemented method, according to one embodiment; and

FIGS. 20 to 21 illustrate example store level data, global level data, and merchant user interfaces, according to some embodiments.

### DETAILED DESCRIPTION

For illustrative purposes, specific example embodiments will now be explained in greater detail below in conjunction with the figures.

Example e-Commerce Platform

The methods disclosed herein may be performed in relation to an e-commerce platform. Therefore, an example of an e-commerce platform will be described.

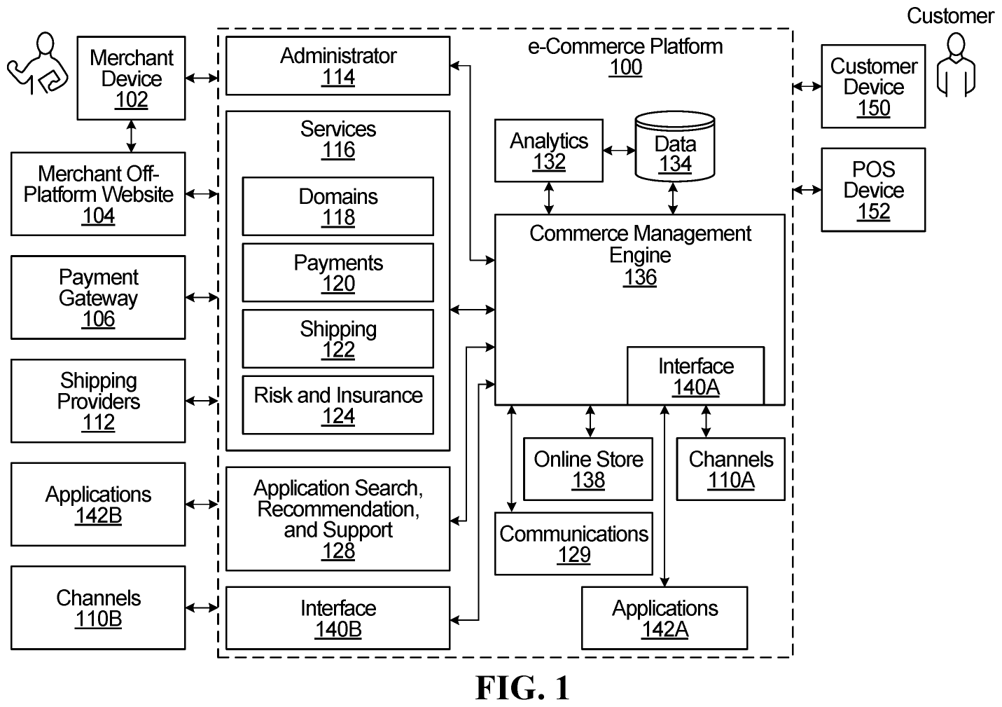

FIG. 1 illustrates an e-commerce platform 100, according to one embodiment. The e-commerce platform 100 may be used to provide merchant products and services to customers. While the disclosure contemplates using the apparatus, system, and process to purchase products and services, for simplicity the description herein will refer to products. All references to products throughout this disclosure should also be understood to be references to products and/or services, including physical products, digital content, tickets, subscriptions, services to be provided, and the like.

While the disclosure throughout contemplates that a ‘merchant’ and a ‘customer’ may be more than individuals, for simplicity the description herein may generally refer to merchants and customers as such. All references to merchants and customers throughout this disclosure should also be understood to be references to groups of individuals, companies, corporations, computing entities, and the like, and may represent for-profit or not-for-profit exchange of products. Further, while the disclosure throughout refers to ‘merchants’ and ‘customers’, and describes their roles as such, the e-commerce platform 100 should be understood to more generally support users in an e-commerce environment, and all references to merchants and customers throughout this disclosure should also be understood to be references to users, such as where a user is a merchant-user (e.g., a seller, retailer, wholesaler, or provider of products), a customer-user (e.g., a buyer, purchase agent, or user of products), a prospective user (e.g., a user browsing and not yet committed to a purchase, a user evaluating the e-commerce platform 100 for potential use in marketing and selling products, and the like), a service provider user (e.g., a shipping provider 112, a financial provider, and the like), a company or corporate user (e.g., a company representative for purchase, sales, or use of products; an enterprise user; a customer relations or customer management agent, and the like), an information technology user, a computing entity user (e.g., a computing bot for purchase, sales, or use of products), and the like.

The e-commerce platform 100 may provide a centralized system for providing merchants with online resources and facilities for managing their business. The facilities described herein may be deployed in part or in whole through a machine that executes computer software, modules, program codes, and/or instructions on one or more processors which may be part of or external to the platform 100. Merchants may utilize the e-commerce platform 100 for managing commerce with customers, such as by implementing an e-commerce experience with customers through an online store 138, through channels 110A-B, through POS devices 152 in physical locations (e.g., a physical storefront or other location such as through a kiosk, terminal, reader, printer, 3D printer, and the like), by managing their business through the e-commerce platform 100, and by interacting with customers through a communications facility 129 of the e-commerce platform 100, or any combination thereof. A merchant may utilize the e-commerce platform 100 as a sole commerce presence with customers, or in conjunction with other merchant commerce facilities, such as through a physical store (e.g., ‘brick-and-mortar’ retail stores), a merchant off-platform website 104 (e.g., a commerce Internet website or other internet or web property or asset supported by or on behalf of the merchant separately from the e-commerce platform), and the like. However, even these ‘other’ merchant commerce facilities may be incorporated into the e-commerce platform, such as where POS devices 152 in a physical store of a merchant are linked into the e-commerce platform 100, where a merchant off-platform website 104 is tied into the e-commerce platform 100, such as through ‘buy buttons’ that link content from the merchant off platform website 104 to the online store 138, and the like.

The online store 138 may represent a multitenant facility comprising a plurality of virtual storefronts. In embodiments, merchants may manage one or more storefronts in the online store 138, such as through a merchant device 102 (e.g., computer, laptop computer, mobile computing device, and the like), and offer products to customers through a number of different channels 110A-B (e.g., an online store 138; a physical storefront through a POS device 152; electronic marketplace, through an electronic buy button integrated into a website or social media channel such as on a social network, social media page, social media messaging system; and the like). A merchant may sell across channels 110A-B and then manage their sales through the e-commerce platform 100, where channels 110A may be provided internal to the e-commerce platform 100 or from outside the e-commerce channel 110B. A merchant may sell in their physical retail store, at pop ups, through wholesale, over the phone, and the like, and then manage their sales through the e-commerce platform 100. A merchant may employ all or any combination of these, such as maintaining a business through a physical storefront utilizing POS devices 152, maintaining a virtual storefront through the online store 138, and utilizing a communication facility 129 to leverage customer interactions and analytics 132 to improve the probability of sales. Throughout this disclosure the terms online store 138 and storefront may be used synonymously to refer to a merchant's online e-commerce offering presence through the e-commerce platform 100, where an online store 138 may refer to the multitenant collection of storefronts supported by the e-commerce platform 100 (e.g., for a plurality of merchants) or to an individual merchant's storefront (e.g., a merchant's online store).

In some embodiments, a customer may interact through a customer device 150 (e.g., computer, laptop computer, mobile computing device, and the like), a POS device 152 (e.g., retail device, a kiosk, an automated checkout system, and the like), or any other commerce interface device known in the art. The e-commerce platform 100 may enable merchants to reach customers through the online store 138, through POS devices 152 in physical locations (e.g., a merchant's storefront or elsewhere), to promote commerce with customers through dialog via electronic communication facility 129, and the like, providing a system for reaching customers and facilitating merchant services for the real or virtual pathways available for reaching and interacting with customers.

In some embodiments, and as described further herein, the e-commerce platform 100 may be implemented through a processing facility including a processor and a memory, the processing facility storing a set of instructions that, when executed, cause the e-commerce platform 100 to perform the e-commerce and support functions as described herein. The processing facility may be part of a server, client, network infrastructure, mobile computing platform, cloud computing platform, stationary computing platform, or other computing platform, and provide electronic connectivity and communications between and amongst the electronic components of the e-commerce platform 100, merchant devices 102, payment gateways 106, application developers, channels 110A-B, shipping providers 112, customer devices 150, point of sale devices 152, and the like. The e-commerce platform 100 may be implemented as a cloud computing service, a software as a service (SaaS), infrastructure as a service (IaaS), platform as a service (PaaS), desktop as a Service (DaaS), managed software as a service (MSaaS), mobile backend as a service (MBaaS), information technology management as a service (ITMaaS), and the like, such as in a software and delivery model in which software is licensed on a subscription basis and centrally hosted (e.g., accessed by users using a client (for example, a thin client) via a web browser or other application, accessed through by POS devices, and the like). In some embodiments, elements of the e-commerce platform 100 may be implemented to operate on various platforms and operating systems, such as iOS, Android, on the web, and the like (e.g., the administrator 114 being implemented in multiple instances for a given online store for iOS, Android, and for the web, each with similar functionality).

In some embodiments, the online store 138 may be served to a customer device 150 through a webpage provided by a server of the e-commerce platform 100. The server may receive a request for the webpage from a browser or other application installed on the customer device 150, where the browser (or other application) connects to the server through an IP Address, the IP address obtained by translating a domain name. In return, the server sends back the requested webpage. Webpages may be written in or include Hypertext Markup Language (HTML), template language, JavaScript, and the like, or any combination thereof. For instance, HTML is a computer language that describes static information for the webpage, such as the layout, format, and content of the webpage. Website designers and developers may use the template language to build webpages that combine static content, which is the same on multiple pages, and dynamic content, which changes from one page to the next. A template language may make it possible to re-use the static elements that define the layout of a webpage, while dynamically populating the page with data from an online store. The static elements may be written in HTML, and the dynamic elements written in the template language. The template language elements in a file may act as placeholders, such that the code in the file is compiled and sent to the customer device 150 and then the template language is replaced by data from the online store 138, such as when a theme is installed. The template and themes may consider tags, objects, and filters. The client device web browser (or other application) then renders the page accordingly.

In some embodiments, online stores 138 may be served by the e-commerce platform 100 to customers, where customers can browse and purchase the various products available (e.g., add them to a cart, purchase immediately through a buy-button, and the like). Online stores 138 may be served to customers in a transparent fashion without customers necessarily being aware that it is being provided through the e-commerce platform 100 (rather than directly from the merchant). Merchants may use a merchant configurable domain name, a customizable HTML theme, and the like, to customize their online store 138. Merchants may customize the look and feel of their website through a theme system, such as where merchants can select and change the look and feel of their online store 138 by changing their theme while having the same underlying product and business data shown within the online store's product hierarchy. Themes may be further customized through a theme editor, a design interface that enables users to customize their website's design with flexibility. Themes may also be customized using theme-specific settings that change aspects, such as specific colors, fonts, and pre-built layout schemes. The online store may implement a content management system for website content. Merchants may author blog posts or static pages and publish them to their online store 138, such as through blogs, articles, and the like, as well as configure navigation menus. Merchants may upload images (e.g., for products), video, content, data, and the like to the e-commerce platform 100, such as for storage by the system (e.g. as data 134). In some embodiments, the e-commerce platform 100 may provide functions for resizing images, associating an image with a product, adding and associating text with an image, adding an image for a new product variant, protecting images, and the like.

As described herein, the e-commerce platform 100 may provide merchants with transactional facilities for products through a number of different channels 110A-B, including the online store 138, over the telephone, as well as through physical POS devices 152 as described herein. The e-commerce platform 100 may include business support services 116, an administrator 114, and the like associated with running an on-line business, such as providing a domain service 118 associated with their online store, payment services 120 for facilitating transactions with a customer, shipping services 122 for providing customer shipping options for purchased products, risk and insurance services 124 associated with product protection and liability, merchant billing, and the like. Services 116 may be provided via the e-commerce platform 100 or in association with external facilities, such as through a payment gateway 106 for payment processing, shipping providers 112 for expediting the shipment of products, and the like.

In some embodiments, the e-commerce platform 100 may provide for integrated shipping services 122 (e.g., through an e-commerce platform shipping facility or through a third-party shipping carrier), such as providing merchants with real-time updates, tracking, automatic rate calculation, bulk order preparation, label printing, and the like.

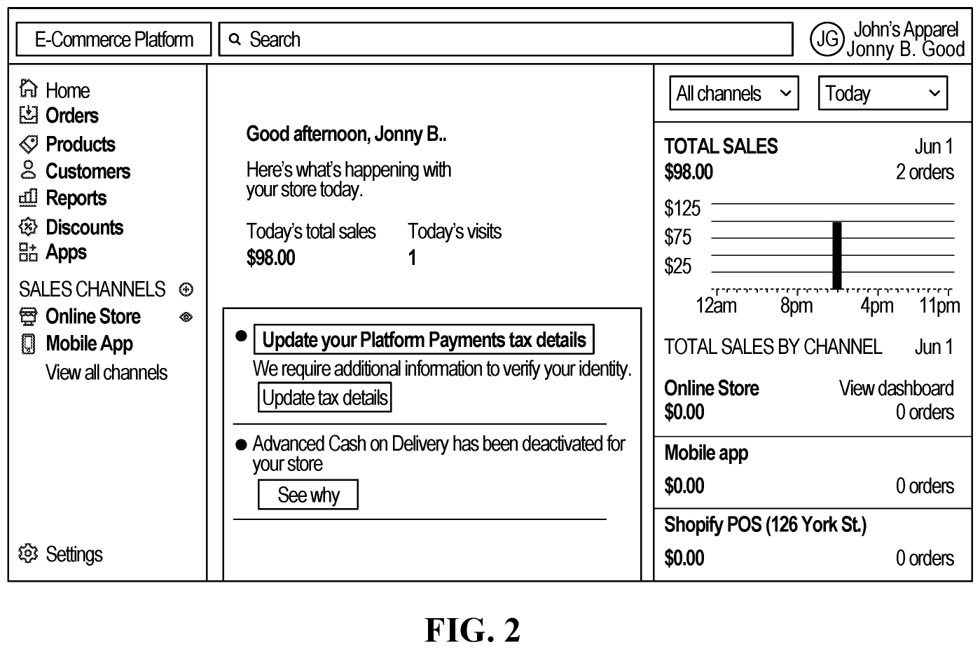

FIG. 2 depicts a non-limiting embodiment for a home page of an administrator 114, which may show information about daily tasks, a store's recent activity, and the next steps a merchant can take to build their business. In some embodiments, a merchant may log in to administrator 114 via a merchant device 102 such as from a desktop computer or mobile device, and manage aspects of their online store 138, such as viewing the online store's 138 recent activity, updating the online store's 138 catalog, managing orders, recent visits activity, total orders activity, and the like. In some embodiments, the merchant may be able to access the different sections of administrator 114 by using the sidebar, such as shown on FIG. 2. Sections of the administrator 114 may include various interfaces for accessing and managing core aspects of a merchant's business, including orders, products, customers, available reports and discounts. The administrator 114 may also include interfaces for managing sales channels for a store including the online store, mobile application(s) made available to customers for accessing the store (Mobile App), POS devices, and/or a buy button. The administrator 114 may also include interfaces for managing applications (Apps) installed on the merchant's account; settings applied to a merchant's online store 138 and account. A merchant may use a search bar to find products, pages, or other information. Depending on the device 102 or software application the merchant is using, they may be enabled for different functionality through the administrator 114. For instance, if a merchant logs in to the administrator 114 from a browser, they may be able to manage all aspects of their online store 138. If the merchant logs in from their mobile device (e.g. via a mobile application), they may be able to view all or a subset of the aspects of their online store 138, such as viewing the online store's 138 recent activity, updating the online store's 138 catalog, managing orders, and the like.

More detailed information about commerce and visitors to a merchant's online store 138 may be viewed through acquisition reports or metrics, such as displaying a sales summary for the merchant's overall business, specific sales and engagement data for active sales channels, and the like. Reports may include, acquisition reports, behavior reports, customer reports, finance reports, marketing reports, sales reports, custom reports, and the like. The merchant may be able to view sales data for different channels 110A-B from different periods of time (e.g., days, weeks, months, and the like), such as by using drop-down menus. An overview dashboard may be provided for a merchant that wants a more detailed view of the store's sales and engagement data. An activity feed in the home metrics section may be provided to illustrate an overview of the activity on the merchant's account. For example, by clicking on a ‘view all recent activity’ dashboard button, the merchant may be able to see a longer feed of recent activity on their account. A home page may show notifications about the merchant's online store 138, such as based on account status, growth, recent customer activity, and the like. Notifications may be provided to assist a merchant with navigating through a process, such as capturing a payment, marking an order as fulfilled, archiving an order that is complete, and the like.

The e-commerce platform 100 may provide for a communications facility 129 and associated merchant interface for providing electronic communications and marketing, such as utilizing an electronic messaging aggregation facility for collecting and analyzing communication interactions between merchants, customers, merchant devices 102, customer devices 150, POS devices 152, and the like, to aggregate and analyze the communications, such as for increasing the potential for providing a sale of a product, and the like. For instance, a customer may have a question related to a product, which may produce a dialog between the customer and the merchant (or automated processor-based agent representing the merchant), where the communications facility 129 analyzes the interaction and provides analysis to the merchant on how to improve the probability for a sale.

The e-commerce platform 100 may provide a financial facility 120 for secure financial transactions with customers, such as through a secure card server environment. The e-commerce platform 100 may store credit card information, such as in payment card industry data (PCI) environments (e.g., a card server), to reconcile financials, bill merchants, perform automated clearing house (ACH) transfers between an e-commerce platform 100 financial institution account and a merchant's back account (e.g., when using capital), and the like. These systems may have Sarbanes-Oxley Act (SOX) compliance and a high level of diligence required in their development and operation. The financial facility 120 may also provide merchants with financial support, such as through the lending of capital (e.g., lending funds, cash advances, and the like) and provision of insurance. In addition, the e-commerce platform 100 may provide for a set of marketing and partner services and control the relationship between the e-commerce platform 100 and partners. They also may connect and onboard new merchants with the e-commerce platform 100. These services may enable merchant growth by making it easier for merchants to work across the e-commerce platform 100. Through these services, merchants may be provided help facilities via the e-commerce platform 100.

In some embodiments, online store 138 may support a great number of independently administered storefronts and process a large volume of transactional data on a daily basis for a variety of products. Transactional data may include customer contact information, billing information, shipping information, information on products purchased, information on services rendered, and any other information associated with business through the e-commerce platform 100. In some embodiments, the e-commerce platform 100 may store this data in a data facility 134. The transactional data may be processed to produce analytics 132, which in turn may be provided to merchants or third-party commerce entities, such as providing consumer trends, marketing and sales insights, recommendations for improving sales, evaluation of customer behaviors, marketing and sales modeling, trends in fraud, and the like, related to online commerce, and provided through dashboard interfaces, through reports, and the like. The e-commerce platform 100 may store information about business and merchant transactions, and the data facility 134 may have many ways of enhancing, contributing, refining, and extracting data, where over time the collected data may enable improvements to aspects of the e-commerce platform 100.

Referring again to FIG. 1, in some embodiments the e-commerce platform 100 may be configured with a commerce management engine 136 for content management, task automation and data management to enable support and services to the plurality of online stores 138 (e.g., related to products, inventory, customers, orders, collaboration, suppliers, reports, financials, risk and fraud, and the like), but be extensible through applications 142A-B that enable greater flexibility and custom processes required for accommodating an ever-growing variety of merchant online stores, POS devices, products, and services, where applications 142A may be provided internal to the e-commerce platform 100 or applications 142B from outside the e-commerce platform 100. In some embodiments, an application 142A may be provided by the same party providing the platform 100 or by a different party. In some embodiments, an application 142B may be provided by the same party providing the platform 100 or by a different party. The commerce management engine 136 may be configured for flexibility and scalability through portioning (e.g., sharding) of functions and data, such as by customer identifier, order identifier, online store identifier, and the like. The commerce management engine 136 may accommodate store-specific business logic and in some embodiments, may incorporate the administrator 114 and/or the online store 138.

The commerce management engine 136 includes base or “core” functions of the e-commerce platform 100, and as such, as described herein, not all functions supporting online stores 138 may be appropriate for inclusion. For instance, functions for inclusion into the commerce management engine 136 may need to exceed a core functionality threshold through which it may be determined that the function is core to a commerce experience (e.g., common to a majority of online store activity, such as across channels, administrator interfaces, merchant locations, industries, product types, and the like), is re-usable across online stores 138 (e.g., functions that can be re-used/modified across core functions), limited to the context of a single online store 138 at a time (e.g., implementing an online store ‘isolation principle’, where code should not be able to interact with multiple online stores 138 at a time, ensuring that online stores 138 cannot access each other's data), provide a transactional workload, and the like. Maintaining control of what functions are implemented may enable the commerce management engine 136 to remain responsive, as many required features are either served directly by the commerce management engine 136 or enabled through an interface 140A-B, such as by its extension through an application programming interface (API) connection to applications 142A-B and channels 110A-B, where interfaces 140A may be provided to applications 142A and/or channels 110A inside the e-commerce platform 100 or through interfaces 140B provided to applications 142B and/or channels 110B outside the e-commerce platform 100. Generally, the platform 100 may include interfaces 140A-B (which may be extensions, connectors, APIs, and the like) which facilitate connections to and communications with other platforms, systems, software, data sources, code and the like. Such interfaces 140A-B may be an interface 140A of the commerce management engine 136 or an interface 140B of the platform 100 more generally. If care is not given to restricting functionality in the commerce management engine 136, responsiveness could be compromised, such as through infrastructure degradation through slow databases or non-critical backend failures, through catastrophic infrastructure failure such as with a data center going offline, through new code being deployed that takes longer to execute than expected, and the like. To prevent or mitigate these situations, the commerce management engine 136 may be configured to maintain responsiveness, such as through configuration that utilizes timeouts, queues, back-pressure to prevent degradation, and the like.

Although isolating online store data is important to maintaining data privacy between online stores 138 and merchants, there may be reasons for collecting and using cross-store data, such as for example, with an order risk assessment system or a platform payment facility, both of which require information from multiple online stores 138 to perform well. In some embodiments, rather than violating the isolation principle, it may be preferred to move these components out of the commerce management engine 136 and into their own infrastructure within the e-commerce platform 100.

In some embodiments, the e-commerce platform 100 may provide for a platform payment facility 120, which is another example of a component that utilizes data from the commerce management engine 136 but may be located outside so as to not violate the isolation principle. The platform payment facility 120 may allow customers interacting with online stores 138 to have their payment information stored safely by the commerce management engine 136 such that they only have to enter it once. When a customer visits a different online store 138, even if they've never been there before, the platform payment facility 120 may recall their information to enable a more rapid and correct check out. This may provide a cross-platform network effect, where the e-commerce platform 100 becomes more useful to its merchants as more merchants join, such as because there are more customers who checkout more often because of the ease of use with respect to customer purchases. To maximize the effect of this network, payment information for a given customer may be retrievable from an online store's checkout, allowing information to be made available globally across online stores 138. It would be difficult and error prone for each online store 138 to be able to connect to any other online store 138 to retrieve the payment information stored there. As a result, the platform payment facility may be implemented external to the commerce management engine 136.

For those functions that are not included within the commerce management engine 136, applications 142A-B provide a way to add features to the e-commerce platform 100. Applications 142A-B may be able to access and modify data on a merchant's online store 138, perform tasks through the administrator 114, create new flows for a merchant through a user interface (e.g., that is surfaced through extensions/API), and the like. Merchants may be enabled to discover and install applications 142A-B through application search, recommendations, and support 128. In some embodiments, core products, core extension points, applications, and the administrator 114 may be developed to work together. For instance, application extension points may be built inside the administrator 114 so that core features may be extended by way of applications, which may deliver functionality to a merchant through the extension.

In some embodiments, applications 142A-B may deliver functionality to a merchant through the interface 140A-B, such as where an application 142A-B is able to surface transaction data to a merchant (e.g., App: “Engine, surface my app data in mobile and web admin using the embedded app SDK”), and/or where the commerce management engine 136 is able to ask the application to perform work on demand (Engine: “App, give me a local tax calculation for this checkout”).

Applications 142A-B may support online stores 138 and channels 110A-B, provide for merchant support, integrate with other services, and the like. Where the commerce management engine 136 may provide the foundation of services to the online store 138, the applications 142A-B may provide a way for merchants to satisfy specific and sometimes unique needs. Different merchants will have different needs, and so may benefit from different applications 142A-B. Applications 142A-B may be better discovered through the e-commerce platform 100 through development of an application taxonomy (categories) that enable applications to be tagged according to a type of function it performs for a merchant; through application data services that support searching, ranking, and recommendation models; through application discovery interfaces such as an application store, home information cards, an application settings page; and the like.

Applications 142A-B may be connected to the commerce management engine 136 through an interface 140A-B, such as utilizing APIs to expose the functionality and data available through and within the commerce management engine 136 to the functionality of applications (e.g., through REST, GraphQL, and the like). For instance, the e-commerce platform 100 may provide API interfaces 140A-B to merchant and partner-facing products and services, such as including application extensions, process flow services, developer-facing resources, and the like. With customers more frequently using mobile devices for shopping, applications 142A-B related to mobile use may benefit from more extensive use of APIs to support the related growing commerce traffic. The flexibility offered through use of applications and APIs (e.g., as offered for application development) enable the e-commerce platform 100 to better accommodate new and unique needs of merchants (and internal developers through internal APIs) without requiring constant change to the commerce management engine 136, thus providing merchants what they need when they need it. For instance, shipping services 122 may be integrated with the commerce management engine 136 through a shipping or carrier service API, thus enabling the e-commerce platform 100 to provide shipping service functionality without directly impacting code running in the commerce management engine 136.

Many merchant problems may be solved by letting partners improve and extend merchant workflows through application development, such as problems associated with back-office operations (merchant-facing applications 142A-B) and in the online store 138 (customer-facing applications 142A-B). As a part of doing business, many merchants will use mobile and web related applications on a daily basis for back-office tasks (e.g., merchandising, inventory, discounts, fulfillment, and the like) and online store tasks (e.g., applications related to their online shop, for flash-sales, new product offerings, and the like), where applications 142A-B, through extension/API 140A-B, help make products easy to view and purchase in a fast growing marketplace. In some embodiments, partners, application developers, internal applications facilities, and the like, may be provided with a software development kit (SDK), such as through creating a frame within the administrator 114 that sandboxes an application interface. In some embodiments, the administrator 114 may not have control over nor be aware of what happens within the frame. The SDK may be used in conjunction with a user interface kit to produce interfaces that mimic the look and feel of the e-commerce platform 100, such as acting as an extension of the commerce management engine 136.

Applications 142A-B that utilize APIs may pull data on demand, but often they also need to have data pushed when updates occur. Update events may be implemented in a subscription model, such as for example, customer creation, product changes, or order cancelation. Update events may provide merchants with needed updates with respect to a changed state of the commerce management engine 136, such as for synchronizing a local database, notifying an external integration partner, and the like. Update events may enable this functionality without having to poll the commerce management engine 136 all the time to check for updates, such as through an update event subscription. In some embodiments, when a change related to an update event subscription occurs, the commerce management engine 136 may post a request, such as to a predefined callback URL. The body of this request may contain a new state of the object and a description of the action or event. Update event subscriptions may be created manually, in the administrator facility 114, or automatically (e.g., via the API 140A-B). In some embodiments, update events may be queued and processed asynchronously from a state change that triggered them, which may produce an update event notification that is not distributed in real-time.

In some embodiments, the e-commerce platform 100 may provide application search, recommendation and support 128. Application search, recommendation and support 128 may include developer products and tools to aid in the development of applications, an application dashboard (e.g., to provide developers with a development interface, to administrators for management of applications, to merchants for customization of applications, and the like), facilities for installing and providing permissions with respect to providing access to an application 142A-B (e.g., for public access, such as where criteria must be met before being installed, or for private use by a merchant), application searching to make it easy for a merchant to search for applications 142A-B that satisfy a need for their online store 138, application recommendations to provide merchants with suggestions on how they can improve the user experience through their online store 138, a description of core application capabilities within the commerce management engine 136, and the like. These support facilities may be utilized by application development performed by any entity, including the merchant developing their own application 142A-B, a third-party developer developing an application 142A-B (e.g., contracted by a merchant, developed on their own to offer to the public, contracted for use in association with the e-commerce platform 100, and the like), or an application 142A or 142B being developed by internal personal resources associated with the e-commerce platform 100. In some embodiments, applications 142A-B may be assigned an application identifier (ID), such as for linking to an application (e.g., through an API), searching for an application, making application recommendations, and the like.

The commerce management engine 136 may include base functions of the e-commerce platform 100 and expose these functions through APIs 140A-B to applications 142A-B. The APIs 140A-B may enable different types of applications built through application development. Applications 142A-B may be capable of satisfying a great variety of needs for merchants but may be grouped roughly into three categories: customer-facing applications, merchant-facing applications, integration applications, and the like. Customer-facing applications 142A-B may include online store 138 or channels 110A-B that are places where merchants can list products and have them purchased (e.g., the online store, applications for flash sales (e.g., merchant products or from opportunistic sales opportunities from third-party sources), a mobile store application, a social media channel, an application for providing wholesale purchasing, and the like). Merchant-facing applications 142A-B may include applications that allow the merchant to administer their online store 138 (e.g., through applications related to the web or website or to mobile devices), run their business (e.g., through applications related to POS devices), to grow their business (e.g., through applications related to shipping (e.g., drop shipping), use of automated agents, use of process flow development and improvements), and the like. Integration applications may include applications that provide useful integrations that participate in the running of a business, such as shipping providers 112 and payment gateways.

In some embodiments, an application developer may use an application proxy to fetch data from an outside location and display it on the page of an online store 138. Content on these proxy pages may be dynamic, capable of being updated, and the like. Application proxies may be useful for displaying image galleries, statistics, custom forms, and other kinds of dynamic content. The core-application structure of the e-commerce platform 100 may allow for an increasing number of merchant experiences to be built in applications 142A-B so that the commerce management engine 136 can remain focused on the more commonly utilized business logic of commerce.

The e-commerce platform 100 provides an online shopping experience through a curated system architecture that enables merchants to connect with customers in a flexible and transparent manner. A typical customer experience may be better understood through an embodiment example purchase workflow, where the customer browses the merchant's products on a channel 110A-B, adds what they intend to buy to their cart, proceeds to checkout, and pays for the content of their cart resulting in the creation of an order for the merchant. The merchant may then review and fulfill (or cancel) the order. The product is then delivered to the customer. If the customer is not satisfied, they might return the products to the merchant.

In an example embodiment, a customer may browse a merchant's products on a channel 110A-B. A channel 110A-B is a place where customers can view and buy products. In some embodiments, channels 110A-B may be modeled as applications 142A-B (a possible exception being the online store 138, which is integrated within the commence management engine 136). A merchandising component may allow merchants to describe what they want to sell and where they sell it. The association between a product and a channel may be modeled as a product publication and accessed by channel applications, such as via a product listing API. A product may have many options, like size and color, and many variants that expand the available options into specific combinations of all the options, like the variant that is extra-small and green, or the variant that is size large and blue. Products may have at least one variant (e.g., a “default variant” is created for a product without any options). To facilitate browsing and management, products may be grouped into collections, provided product identifiers (e.g., stock keeping unit (SKU)) and the like. Collections of products may be built by either manually categorizing products into one (e.g., a custom collection), by building rulesets for automatic classification (e.g., a smart collection), and the like. Products may be viewed as 2D images, 3D images, rotating view images, through a virtual or augmented reality interface, and the like.

In some embodiments, the customer may add what they intend to buy to their cart (in an alternate embodiment, a product may be purchased directly, such as through a buy button as described herein). Customers may add product variants to their shopping cart. The shopping cart model may be channel specific. The online store 138 cart may be composed of multiple cart line items, where each cart line item tracks the quantity for a product variant. Merchants may use cart scripts to offer special promotions to customers based on the content of their cart. Since adding a product to a cart does not imply any commitment from the customer or the merchant, and the expected lifespan of a cart may be in the order of minutes (not days), carts may be persisted to an ephemeral data store.

The customer then proceeds to checkout. A checkout component may implement a web checkout as a customer-facing order creation process. A checkout API may be provided as a computer-facing order creation process used by some channel applications to create orders on behalf of customers (e.g., for point of sale). Checkouts may be created from a cart and record a customer's information such as email address, billing, and shipping details. On checkout, the merchant commits to pricing. If the customer inputs their contact information but does not proceed to payment, the e-commerce platform 100 may provide an opportunity to re-engage the customer (e.g., in an abandoned checkout feature). For those reasons, checkouts can have much longer lifespans than carts (hours or even days) and are therefore persisted. Checkouts may calculate taxes and shipping costs based on the customer's shipping address. Checkout may delegate the calculation of taxes to a tax component and the calculation of shipping costs to a delivery component. A pricing component may enable merchants to create discount codes (e.g., ‘secret’ strings that when entered on the checkout apply new prices to the items in the checkout). Discounts may be used by merchants to attract customers and assess the performance of marketing campaigns. Discounts and other custom price systems may be implemented on top of the same platform piece, such as through price rules (e.g., a set of prerequisites that when met imply a set of entitlements). For instance, prerequisites may be items such as “the order subtotal is greater than $100” or “the shipping cost is under $10”, and entitlements may be items such as “a 20% discount on the whole order” or “$10 off products X, Y, and Z”.

Customers then pay for the content of their cart resulting in the creation of an order for the merchant. Channels 110A-B may use the commerce management engine 136 to move money, currency or a store of value (such as dollars or a cryptocurrency) to and from customers and merchants. Communication with the various payment providers (e.g., online payment systems, mobile payment systems, digital wallet, credit card gateways, and the like) may be implemented within a payment processing component. The actual interactions with the payment gateways 106 may be provided through a card server environment. In some embodiments, the payment gateway 106 may accept international payment, such as integrating with leading international credit card processors. The card server environment may include a card server application, card sink, hosted fields, and the like. This environment may act as the secure gatekeeper of the sensitive credit card information. In some embodiments, most of the process may be orchestrated by a payment processing job. The commerce management engine 136 may support many other payment methods, such as through an offsite payment gateway 106 (e.g., where the customer is redirected to another website), manually (e.g., cash), online payment methods (e.g., online payment systems, mobile payment systems, digital wallet, credit card gateways, and the like), gift cards, and the like. At the end of the checkout process, an order is created. An order is a contract of sale between the merchant and the customer where the merchant agrees to provide the goods and services listed on the orders (e.g., order line items, shipping line items, and the like) and the customer agrees to provide payment (including taxes). This process may be modeled in a sales component. Channels 110A-B that do not rely on commerce management engine 136 checkouts may use an order API to create orders. Once an order is created, an order confirmation notification may be sent to the customer and an order placed notification sent to the merchant via a notification component. Inventory may be reserved when a payment processing job starts to avoid over-selling (e.g., merchants may control this behavior from the inventory policy of each variant). Inventory reservation may have a short time span (minutes) and may need to be very fast and scalable to support flash sales (e.g., a discount or promotion offered for a short time, such as targeting impulse buying). The reservation is released if the payment fails. When the payment succeeds, and an order is created, the reservation is converted into a long-term inventory commitment allocated to a specific location. An inventory component may record where variants are stocked, and tracks quantities for variants that have inventory tracking enabled. It may decouple product variants (a customer facing concept representing the template of a product listing) from inventory items (a merchant facing concept that represent an item whose quantity and location is managed). An inventory level component may keep track of quantities that are available for sale, committed to an order or incoming from an inventory transfer component (e.g., from a vendor).

The merchant may then review and fulfill (or cancel) the order. A review component may implement a business process merchant's use to ensure orders are suitable for fulfillment before actually fulfilling them. Orders may be fraudulent, require verification (e.g., ID checking), have a payment method which requires the merchant to wait to make sure they will receive their funds, and the like. Risks and recommendations may be persisted in an order risk model. Order risks may be generated from a fraud detection tool, submitted by a third-party through an order risk API, and the like. Before proceeding to fulfillment, the merchant may need to capture the payment information (e.g., credit card information) or wait to receive it (e.g., via a bank transfer, check, and the like) and mark the order as paid. The merchant may now prepare the products for delivery. In some embodiments, this business process may be implemented by a fulfillment component. The fulfillment component may group the line items of the order into a logical fulfillment unit of work based on an inventory location and fulfillment service. The merchant may review, adjust the unit of work, and trigger the relevant fulfillment services, such as through a manual fulfillment service (e.g., at merchant managed locations) used when the merchant picks and packs the products in a box, purchase a shipping label and input its tracking number, or just mark the item as fulfilled. A custom fulfillment service may send an email (e.g., a location that doesn't provide an API connection). An API fulfillment service may trigger a third party, where the third-party application creates a fulfillment record. A legacy fulfillment service may trigger a custom API call from the commerce management engine 136 to a third party (e.g., fulfillment by Amazon). A gift card fulfillment service may provision (e.g., generating a number) and activate a gift card. Merchants may use an order printer application to print packing slips. The fulfillment process may be executed when the items are packed in the box and ready for shipping, shipped, tracked, delivered, verified as received by the customer, and the like.

If the customer is not satisfied, they may be able to return the product(s) to the merchant. The business process merchants may go through to “un-sell” an item may be implemented by a return component. Returns may consist of a variety of different actions, such as a restock, where the product that was sold actually comes back into the business and is sellable again; a refund, where the money that was collected from the customer is partially or fully returned; an accounting adjustment noting how much money was refunded (e.g., including if there was any restocking fees, or goods that weren't returned and remain in the customer's hands); and the like. A return may represent a change to the contract of sale (e.g., the order), and where the e-commerce platform 100 may make the merchant aware of compliance issues with respect to legal obligations (e.g., with respect to taxes). In some embodiments, the e-commerce platform 100 may enable merchants to keep track of changes to the contract of sales over time, such as implemented through a sales model component (e.g., an append-only date-based ledger that records sale-related events that happened to an item).

Implementing a Global Data Model in the e-Commerce Platform 100

For each store associated with a merchant account on the e-commerce platform 100, the e-commerce platform 100 stores a respective catalog of products. Each product has a set of attributes that are stored in relation to the product, e.g. as data 134 in memory. The merchant may view the catalog of products for each store and the corresponding set of attributes of each product sold in each store using a user interface on their merchant device 102.

The set consisting of every product that is for sale by the merchant in one or more of the merchant's stores will be referred to as the global collection of products. In some embodiments, the e-commerce platform 100 implements a global data model that stores for each merchant: (1) an indication of each product in the global collection of products, (2) an indication of in which ones of the merchant's stores the product is offered for sale, and (3) an indication of which attributes of that product are the same across the different stores in which that product is offered for sale and/or an indication of which attributes of that product are different across the different stores in which that product is offered for sale.

In some embodiments, the e-commerce platform 100 implements a product matching algorithm that, for each merchant, traverses the product catalog of each store belonging to the merchant to identify a same product across two or more stores.

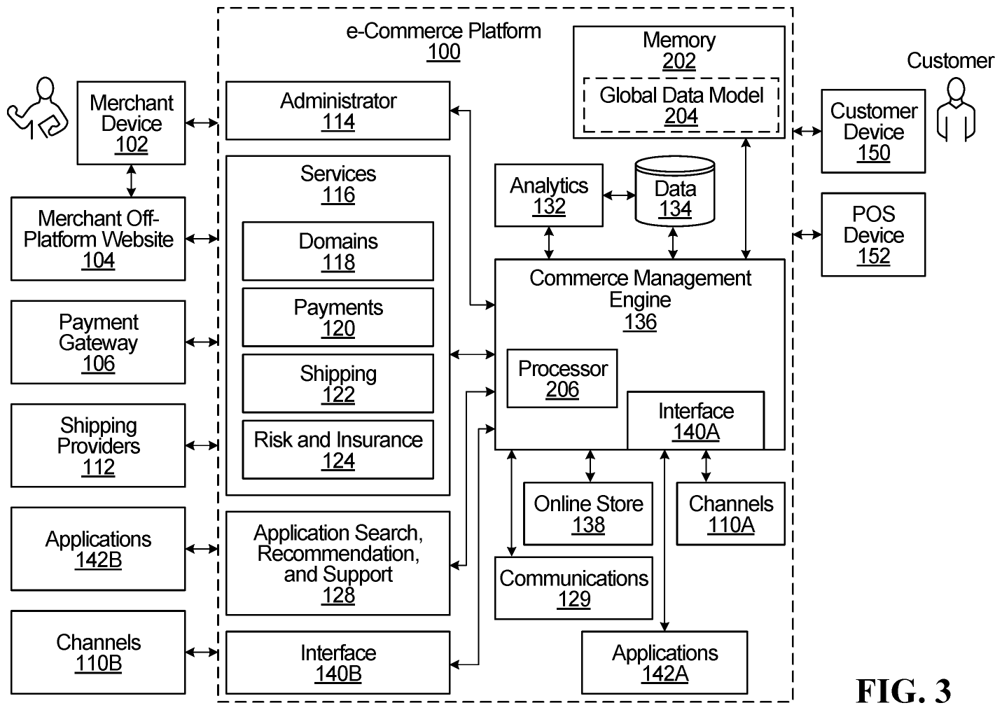

FIG. 3 illustrates the e-commerce platform 100 of FIG. 1, but with a memory 202 to store a global data model 204, and a processor 206 in the commerce management engine 136 that generates and maintains the global data model 204. For example, the processor 206 may implement the product matching algorithm described herein as part of generating the global data model. The processor 206 may be implemented by one or more general-purpose processors that execute instructions stored in a memory. The instructions, when executed, cause the processor 206 to perform operations to generate and maintain the global data model 204. Alternatively, some or all the processor 206 may be implemented using dedicated circuitry, such as an application specific integrated circuit (ASIC), a graphics processing unit (GPU), or a programmed field programmable gate array (FPGA). In some embodiments, the processor 206 may be used to implement other operations in the e-commerce platform 100. In some embodiments, the memory 202 may be part of the database storing data 134, and the data 134 may include the global data model 204.

Although the embodiments described below may be implemented using processor 206 and global data model 204 in e-commerce platform 100, the embodiments described below are not limited to the specific e-commerce platform 100 of FIGS. 1 to 3 and could be used in connection with any e-commerce platform. Other implementations are also contemplated. In some implementations, the functionality described herein may be implemented as a stand-alone component or service (e.g. external to the e-commerce platform 100) or implemented at least in part by a user device such as a merchant device. For simplicity, the embodiments below will be described generally in relation to an e-commerce platform.

### Store-Level Data and Global-Level Data Model

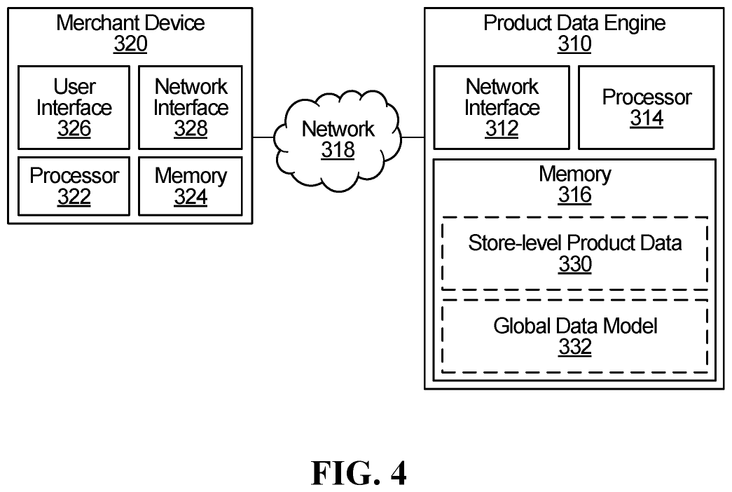

FIG. 4 illustrates a system for implementing store-level data storage and a global-level data model for merchants, according to one embodiment.

The system includes a product data engine 310. The product data engine 310 implements store-level data storage and a global-level data model for merchants. The product data engine 310 may be part of an e-commerce platform, e.g. e-commerce platform 100. For example, the product data engine 310 may be implemented by processor 206 of FIG. 3 and include global data model 204 illustrated in FIG. 3. However, this is only an example. The product data engine 310 could also or instead be provided by another component of an e-commerce platform or implemented as a stand-alone component or service that is external to an e-commerce platform. In some embodiments, either or both of the applications 142A-B of FIG. 3 provide the product data engine in the form of a downloadable application that is available for installation in relation to a merchant account. In addition, at least a portion of the product data engine could be implemented on a merchant device, e.g. on merchant device 102 of FIG. 3 or on merchant device 320 described below. For example, the merchant device could store and run some or all of the product data engine 310 locally as a software application.

In many of the examples below, the product data engine 310 is assumed to be part of an e-commerce platform. However, as explained above, this is not necessary.

The product data engine 310 of FIG. 3 includes or has access to a network interface 312, a processor 314, and a memory 316. The network interface 312 is for communicating over network 318. The network interface 312 may be implemented as a network interface card (NIC), and/or a computer port (e.g. a physical outlet to which a plug or cable connects), and/or a network socket, etc., depending upon the implementation. The processor 314 directly performs, or instructs the product data engine 310 to perform, the operations of the product data engine 310 described herein, e.g. creating and maintaining the global data model, implementing the product matching algorithm, etc. The processor 314 may be implemented by one or more general purpose processors that execute instructions stored in a memory (e.g. in memory 316). The instructions, when executed, cause the processor 314 to directly perform, or instruct the product data engine 310 to perform, the operations described herein. In other embodiments, the processor 314 may be implemented using dedicated circuitry, such as a programmed FPGA, a GPU, or an ASIC.

A plurality of merchants access the product data engine 310 over the network 318 using merchant devices, e.g. to establish and manage online stores to sell products. For ease of explanation, only a single merchant device 320 is illustrated in FIG. 4. The merchant device 320 includes a processor 322, a memory 324, a user interface 326, and a network interface 328. The processor 322 directly performs, or instructs the merchant device 320 to perform, the operations of the merchant device 320 described herein, e.g. communicating with the product data engine 310 to receive and display the merchant's global product catalog on the user interface 326, instructing modification of product attributes in the global product catalog (e.g. based on merchant user input via user interface 326), etc. The processor 322 may be implemented by one or more general purpose processors that execute instructions stored in a memory (e.g. memory 324). The instructions, when executed, cause the processor 322 to directly perform, or instruct the merchant device 320 to perform, the operations described herein. In other embodiments, the processor 322 may be implemented using dedicated circuitry, such as a programmed FPGA, a GPU, or an ASIC. The user interface 326 may be implemented as a display screen (which may be a touch screen), and/or a keyboard, and/or a mouse, etc., depending upon the implementation. The network interface 328 is for communicating with the product data engine 310 over the network 318. The structure of the network interface 328 will depend on how the merchant device 320 interfaces with the network 318. For example, if the merchant device 320 is a mobile phone or tablet, the network interface 328 may comprise a transmitter/receiver with an antenna to send and receive wireless transmissions to/from the network 318. If the merchant device 320 is a personal computer connected to the network 318 with a network cable, the network interface 328 may comprise a network interface card (NIC), and/or a computer port (e.g. a physical outlet to which a plug or cable connects), and/or a network socket, etc.

A merchant may manage multiple stores, each with its own separate inventory, orders, domain name (or subdomain), currency, etc. Each store managed by a same merchant (and associated with that merchant's account) sells a respective catalog of products. Each product has a set of attributes that are stored in the product data engine 310 in relation to the product. Examples of attributes include title of the product, color of the product, description of the product, number of units in stock (inventory), product ID (such as stock-keeping unit (SKU)), price of the product, etc. The indication of each product for sale in each store, along with the corresponding attributes of that product, is stored as store-level product data 330 in memory 316 of the product data engine 310.

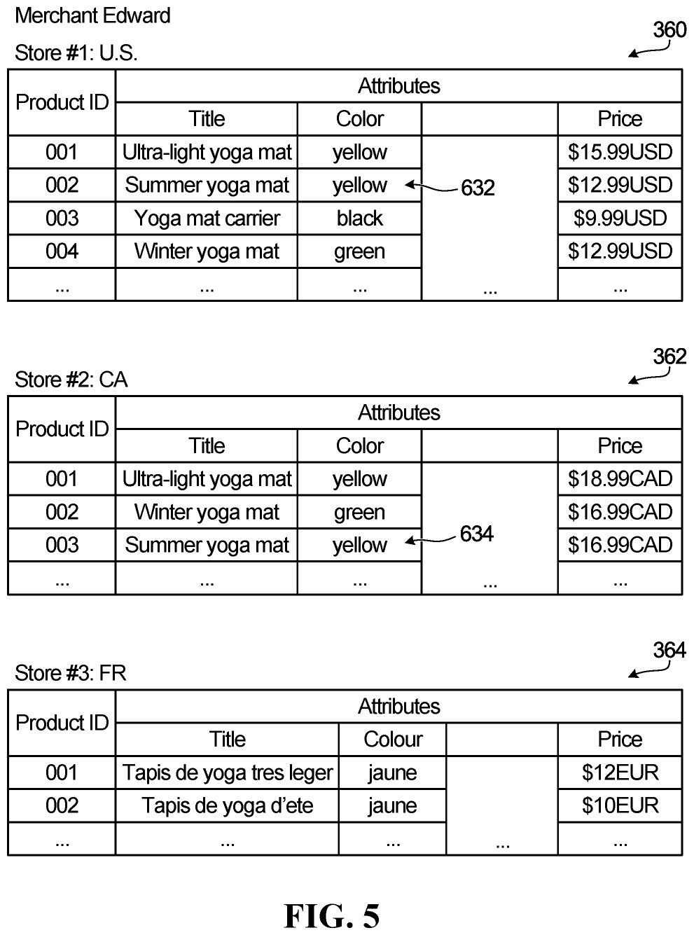

FIG. 5 illustrates example store-level data 330 for one merchant, which will be referred to herein as “Merchant Edward”. Merchant Edward sells yoga mats and yoga mat carriers. Merchant Edward manages three online stores to sell his products: yogamat.com, which is the U.S. store, ca.yogamat.com, which is the Canada-specific store, and fr.yogamat.com, which is the France-specific store. The three stores are associated with Merchant Edward's merchant account. Product data for Merchant Edward's U.S. store is stored in table 360 in memory. Product data for Merchant Edward's Canada store is stored in table 362 in memory. Product data for Merchant Edward's France store is stored in table 364 in memory. Although tables are illustrated in FIG. 5, in actual implementation the stored data may not be stored in a table format.

Each one of Merchant Edward's stores has its own separate inventory, orders, subdomain name, currency, etc. Each product offered for sale in each store is assigned an identifier (ID) that is unique within that store. Each product offered for sale in each store also has stored information describing attributes of that product.

For example, Merchant Edward's U.S. store is associated with a respective catalog of products, each product in the catalog corresponding to a respective row in table 360. Each row in table 360 indicates one product for sale in the U.S. store, and the row also stores information describing attributes of that product. For example, product ID 002 is a product for sale on Merchant Edward's U.S. store that has the following attributes (only a few of which are illustrated in table 360):
Product title=“Summer yoga mat”
Color=“Yellow”
Description=“A light and bright yoga mat perfect for yoga on the run on a bright summer day. Throw it in your backpack and go!”
Dimensions=24 inches width/70 inches length
Vendor=“Sports Products Inc.”
Product material=“recycled rubber”
Image (e.g. picture of product uploaded by merchant)
Inventory in stock=137 units
SKU=MJSY02SMYE
Price=$12.99 USD

The attributes are used to store information about the product. Some of the attributes may be predefined by the product data engine 310, and the value of that attribute is provided by the merchant, e.g. price. Other attributes may be merchant-defined, e.g. via a key value data field. An example of a merchant-defined attribute may be a characteristic of a surface of a yoga mat, which may be populated by the merchant as “uneven surface” or “smooth surface” or “diamond pattern”, etc.

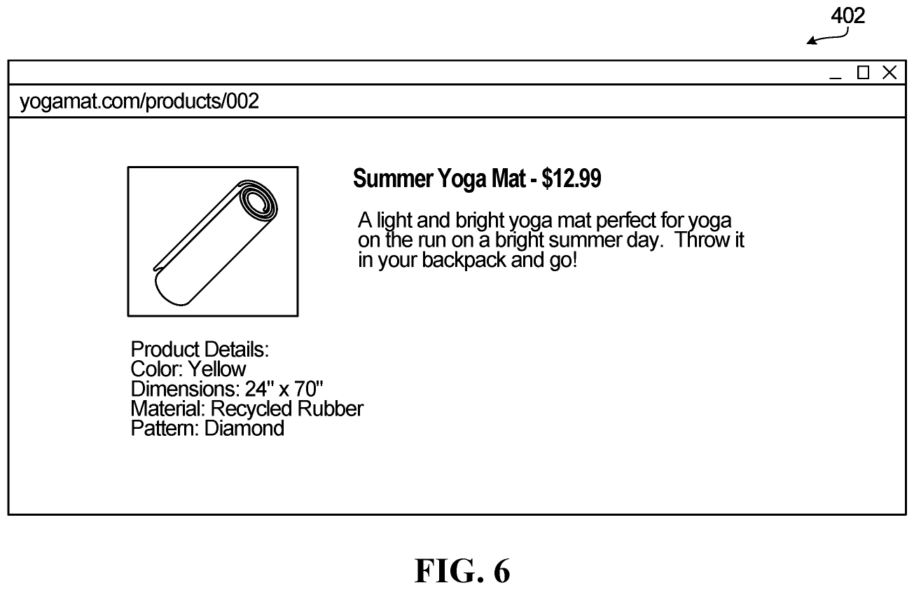

At least some of the attributes are used to populate information about the product on the product's webpage. For example, FIG. 6 illustrates a product webpage 402 for product ID 002 on Merchant Edward's U.S. store. Attributes associated with product ID 002 and stored in table 360 are populated on the product page, e.g. the product title, an image of the product, the product description, etc.

Different stores associated with a same merchant account may sell different products. For example, Merchant Edward's U.S. store sells a yoga mat carrier (product ID 003 in table 360), which is not sold in any of Merchant Edward's other stores. Different stores belonging to a same merchant may also sell the same product. For example, Merchant Edward sells the summer yoga mat in the U.S., Canada, and France store. Even though the same product may be sold across different stores, each store has associated in memory a separate indication of the product and associated attributes, so that the attributes can be customized to each store. For example, the attributes of the summer yoga mat sold in the Canada store (listed as product ID 003 in table 362) may be as follows:
Product title=“Summer yoga mat”
Colour=“Yellow”
Description=“A light and bright yoga mat perfect for yoga on the run on a bright summer day. Throw it in your knapsack and go!”
Dimensions=24 inches width/70 inches length
Vendor=“Sports Products Inc.”
Product material=“recycled rubber”
Image (e.g. same picture of product as used for U.S. store)
Inventory in stock=45 units
SKU=MJSY02SMYE
Price=$16.99 CAD

Some of the attributes of the summer yoga mat are the same as the U.S. store (e.g. product title=summer yoga mat), some of the attributes are different from the U.S. store (e.g. price), and some of the attributes are only slightly different from the U.S. store to reflect cultural or language differences between countries (e.g. the product description in the Canada store uses the word “knapsack” instead of “backpack”).

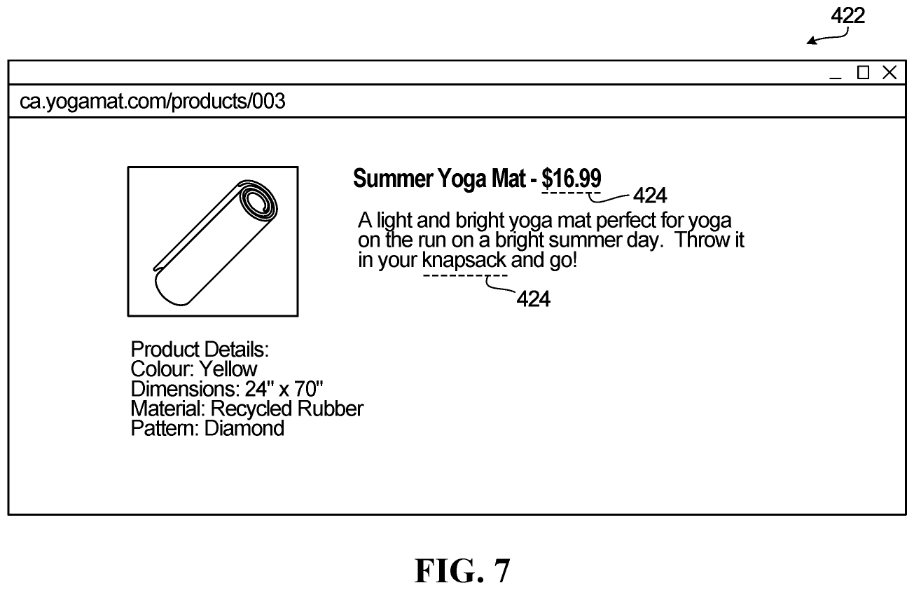

FIG. 7 illustrates a product webpage 422 for the summer yoga mat on Merchant Edward's Canada store. The attributes displayed to describe the product are retrieved from table 362 of FIG. 5. Differences from the product page for the U.S. store are shown using reference character 424 in FIG. 7.

The attributes of the summer yoga mat sold in the France store (listed as product ID 002 in table 364) may be as follows:
Product title=“Tapis de yoga d′éte”
Colour=“Jaune”
Description=“Un tapis de yoga léger et lumineux parfait pour le yoga sur la course par une belle journée d'été. Jetez-le dans votre sac á dos et c'est parti!”
Dimensions=24 inches width/70 inches length
Vendor=“Euro Sports Corporation”
Product material=“caoutchouc recycle”
Image (e.g. same picture of product as used for U.S. store)
Inventory in stock=75 units
SKU=MJSY02SMYE
Price=$10 EUR

The attributes are the same as the U.S. store, except: text translated into French where appropriate, a different vendor (e.g. based in Europe), different inventory in stock, and different price.

Merchant Edward may use his merchant device 320 to access an administrator web page that allows Merchant Edward to view the products sold in each store, to modify the attributes of those products, and to add or remove products. Any addition of a product, deletion of a product, or modification of an attribute of a product is reflected in the store-level data, e.g. in table 360 of FIG. 5 if the change relates to the U.S. store, in table 362 of FIG. 5 if the change relates to the Canada store, or in table 364 of FIG. 5 if the change relates to the France store.

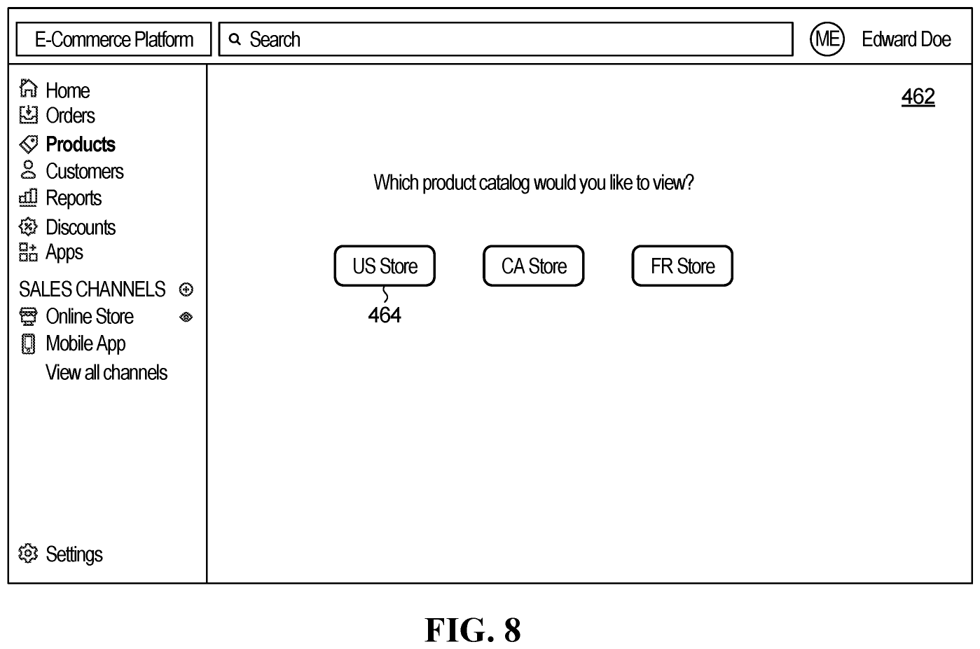

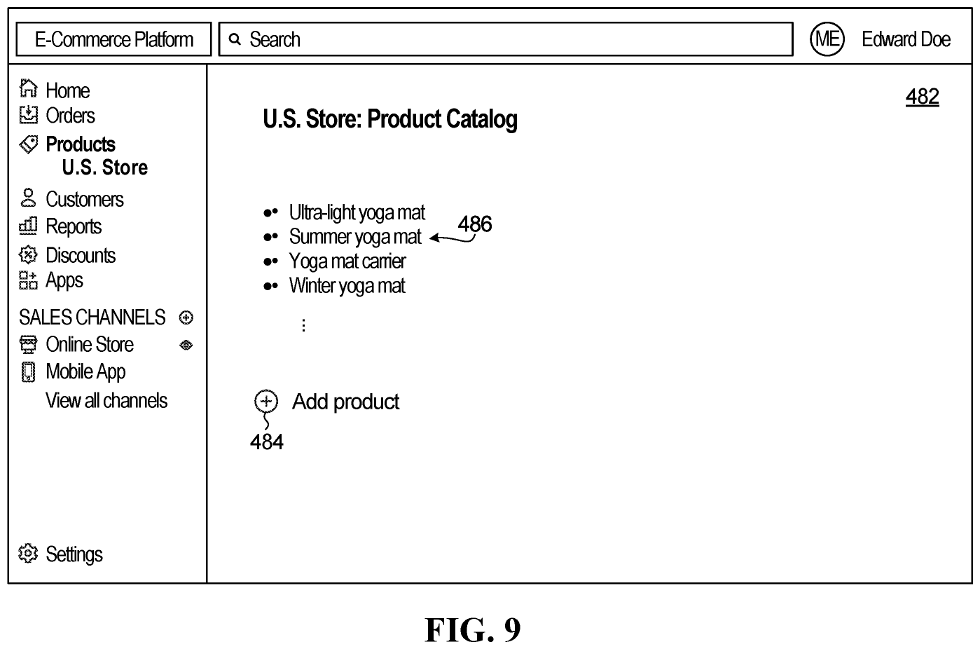

FIG. 8 illustrates an administrator web page 462 providing an option for Merchant Edward to enter (e.g. log into) a particular one of Merchant Edward's stores. The webpage 462 is generated by the processor 314 of product data engine 310 and transmitted to Merchant Edward's merchant device 320 for presentation on the user interface 326 of the merchant device 320. Merchant Edward selects a particular store by selecting the input object on the web page corresponding to that store, e.g. by selecting button 464 to enter the U.S. store. Assuming Merchant Edward selects to enter the U.S. store, FIG. 9 illustrates a web page 482 specific to the U.S. store. The catalog of products sold in that store are listed. A new product for the U.S. store may be added by selecting input object (e.g. button) 484.

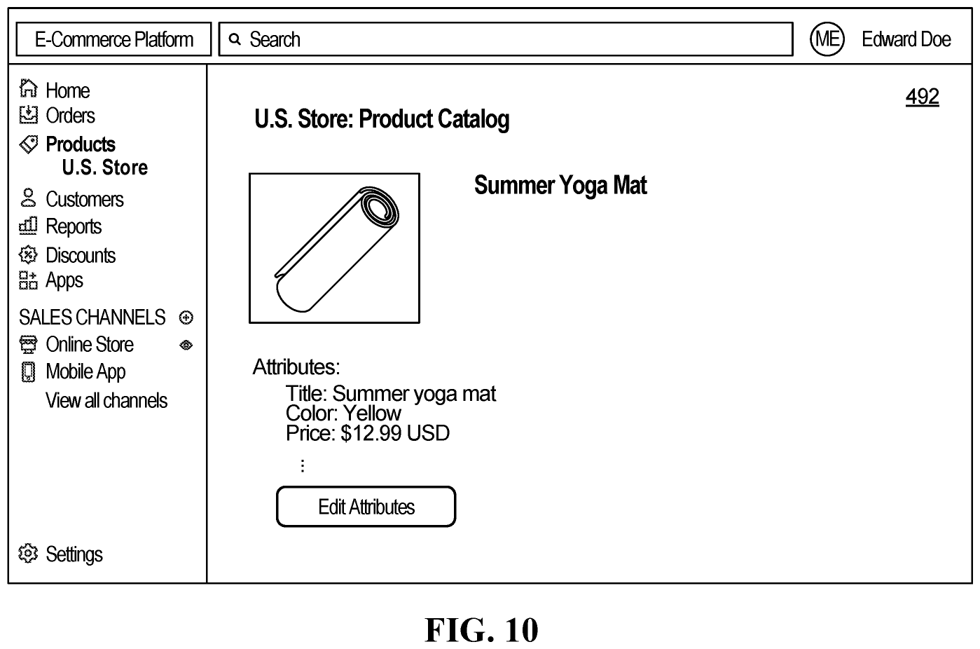

Assuming Merchant Edward selects the product ‘Summer Yoga Mat’ 486, then FIG. 10 illustrates a web page 492 specific to the ‘Summer Yoga Mat’ product for sale on the U.S. store. The attributes are listed and may be edited, i.e. modified, using the user interface 326 of Merchant Edward's merchant device 320. Any modification made by Merchant Edward is reflected in table 360 of FIG. 5. A sale of a unit of the ‘Summer Yoga Mat’ product on the U.S. store may also modify one or more of the attributes reflected in table 360, e.g. the inventory of the product in the U.S. store may be automatically decremented by one unit.

To instead view the products in the Canada store and their attributes, Merchant Edward must return to web page 462 of FIG. 8 and select the Canada store instead. To view the products in the France store and their attributes, Merchant Edward must return to web page 462 of FIG. 8 and select the France store instead. Depending upon the access permissions, some employees of Merchant Edward may not have access to all three stores, e.g. an employee only working for the U.S. store may only be able to access the web pages in FIGS. 9 and 10 that are specific to the U.S. store, and not view or modify the product catalog or product attributes of the products sold in the Canada and France stores.

Having separate product catalogs at the store level, e.g. as stored in the tables in FIG. 5, allows for a merchant to customize the attributes of a product according to the store. For example, compared to the U.S. store, a yoga mat for sale in the Canada store may have a price in Canadian dollars (instead of U.S. dollars), use culturally specific language (e.g. “knapsack” instead of “backpack”) and have a separate vendor (e.g. based in Canada) with separate inventory count.

However, the storage model illustrated in FIG. 5 and associated product-specific web pages on the merchant user interface, e.g. as shown in FIGS. 8 to 10, results in the following computer problem: it is a challenge for the computer to provide a merchant interface that provides a view of a global collection of products for sale by the merchant, because the computer stores separate product catalogs at the store level, as shown in FIG. 5. A global collection of products for sale by a merchant is the set consisting of every product that is for sale by the merchant in one or more of the merchant's stores. To view the global collection, Merchant Edward would be required to enter the product catalog for the U.S. store and note the products for sale in that store, then do the same for the Canada store, and then do the same for the France store. Moreover, if that same product is to have a common attribute modified (e.g. if the color of the summer yoga mat is to be changed from “yellow” to “cream”), then, due to the limitations of the computer storage model, Merchant Edward must use his user interface to separately enter the configuration settings of each store, search to determine if the product is sold in that store, and assuming so then manually make the change. This manual process must be repeated for each store to update each of the tables in FIG. 5, as necessary.

To help address the problem above, a portion of memory in the product data engine 310 may be allocated and organized to facilitate display of the global collection of products for sale by each merchant independent of the merchant's particular stores. For example, returning to FIG. 4, a global data model 332 may be stored in memory 316 of the product data engine 310.

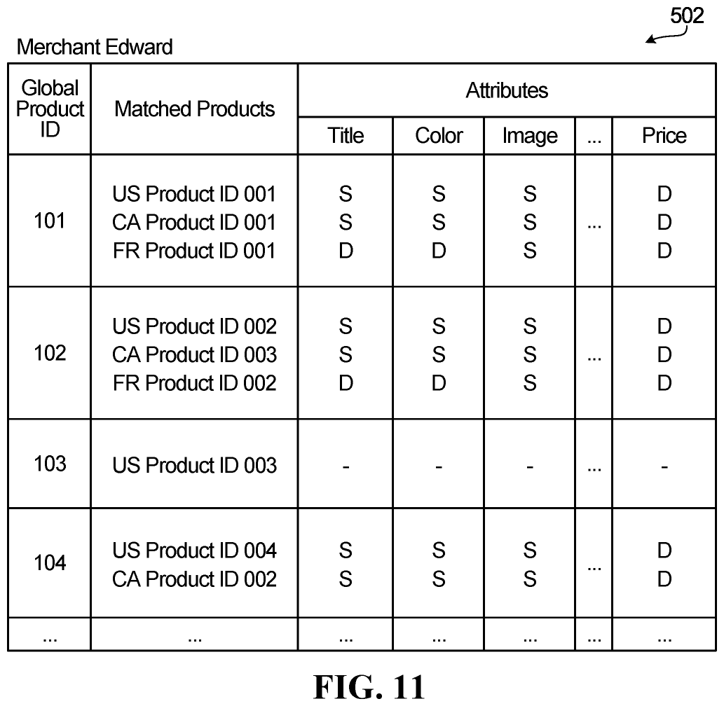

An example of a global data model 332 for Merchant Edward is illustrated in FIG. 11 as a table 502, although in actual implementation the stored data may not be stored in a table format. The table 502 is stored in memory separate and independent from store-level tables 360, 362, and 364 of FIG. 5. The table 502 in FIG. 11 includes a separate memory allocation (described and illustrated as a row) for each product offered for sale by Merchant Edward in any one or more of the stores managed by Merchant Edward. Each row is assigned a unique product ID that corresponds to a unique product sold in one or more of Merchant Edward's stores. For a given unique product (i.e. for a given row of the table 502), the product ID of the product for each store in which the product is sold is recorded. The corresponding attributes that are the same across the stores are indicated (e.g. using “S” in table 502), and the corresponding attributes that differ across the stores are indicated (e.g. using “D” in table 502).

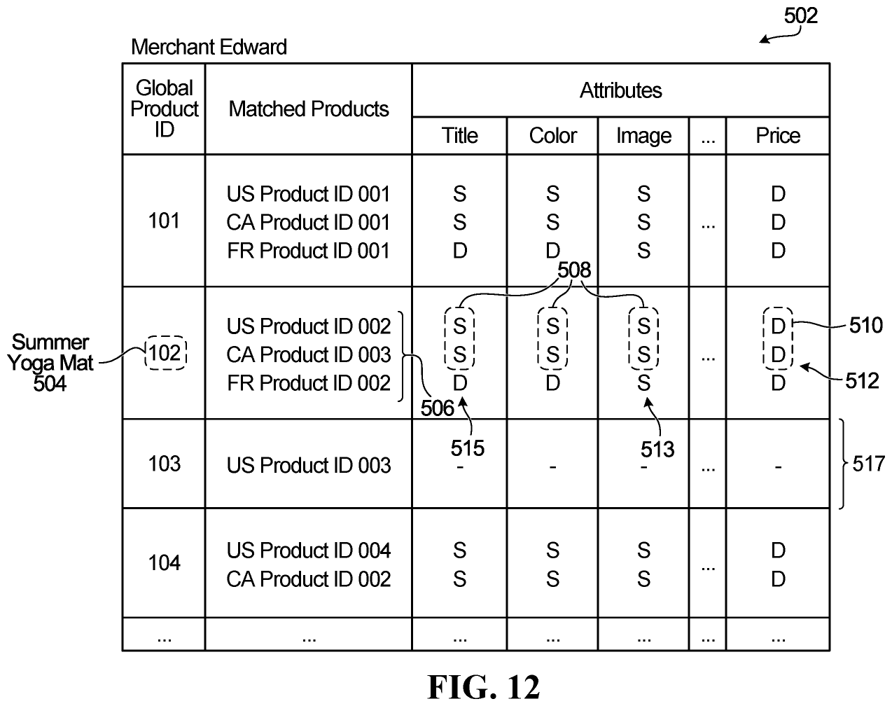

An example will be explained with reference to FIG. 12. FIG. 12 is a repeat of FIG. 11, but showing additional reference characters and markings. Global product ID 102 in table 502 corresponds to the summer yoga mat, as shown at 504. The summer yoga mat is sold in all three of Merchant Edward's stores. According to the store-level data in FIG. 5, the product ID for the summer yoga mat in Merchant Edward's U.S. store is 002, the product ID for the summer yoga mat in Merchant Edward's Canada store is 003, and the product ID for the summer yoga mat in Merchant Edward's France store is 002. Therefore, an indication is stored in memory in the table that these three IDs all relate to the same (matched) product, as shown at 506. Because the product is the same across all three stores, many of the attributes are also the same across all three stores. However, some attributes may be different. Comparing the summer yoga mat product as offered for sale in the U.S. store compared to the Canada store, it is the case that the title, color, and image of the product are the same across both stores. This is indicated in memory, e.g. as represented by the “S” in table 502, as shown at 508. However, the price is different in the U.S. and Canada stores. This is also indicated in memory, e.g. as represented by the “D” in table 502, as shown at 510. Note that in some embodiments the processor 314 may determine whether the image of the product is the same across two stores by comparing a hash of the image. For example, it may determined that the image of the product used for the U.S. store is the same as the image of the product used for the Canada store if the hash of the image used for the U.S. store is equal to the hash of the image used for the Canada store.

The global data model implemented via table 502 in memory might not store the attribute values themselves because these are stored as part of the store-specific data in FIG. 5. Instead, table 502 stores an indication of which products in the merchant's collection are the same, and of those products that are the same, which attributes are the same across the multiple stores and which attributes are different. Note that the yoga mat carrier is only sold in the U.S. store (as product ID 003), and so the row entry 517 corresponding to that product does not indicate multiple matched products across different stores, and so there is not an indication of the same or different attributes across different stores because the product is only sold in one store.

The global data model illustrated as table 502 in FIGS. 11 and 12 has the advantage that the underlying attribute values themselves are not stored, but rather relationships are stored, e.g. indications of product matches and whether the attributes are the same or different across different stores. The store-level data in FIG. 5 stores the actual attribute values for each product for each store, and the relationships stored in FIGS. 11 and 12 simply reflect the store-level data in FIG. 5. When the store-level data (e.g. attribute values) change and one or more of the entries in the tables of FIG. 5 is modified, then the relationships stored in FIGS. 11 and 12 are modified as necessary. Similarly, when a new product is added to or removed from one of the tables in FIG. 5, the relationships stored in FIGS. 11 and 12 are modified as necessary.

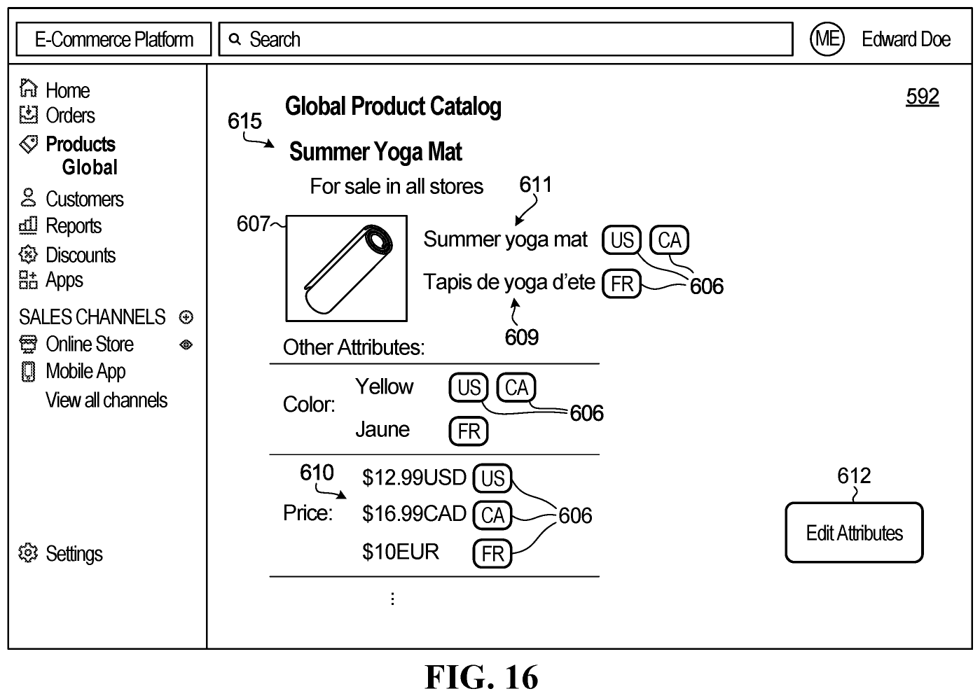

In operation, when the merchant requests a global catalog view, the relationships stored in the table 502 in FIG. 11 may be used to determine which products and corresponding attributes are to be transmitted for display on the merchant device. If a particular attribute is the same for a same product across two or more stores, then in some embodiments only that attribute value from one of the stores (e.g. the U.S. store) is displayed. The store from which the attribute is retrieved for display may be set by the merchant. If a particular attribute is different for a same product across two or more stores, then in some embodiments both attributes from both stores are retrieved and sent for display on the merchant device. An example is described later in relation to FIG. 16.

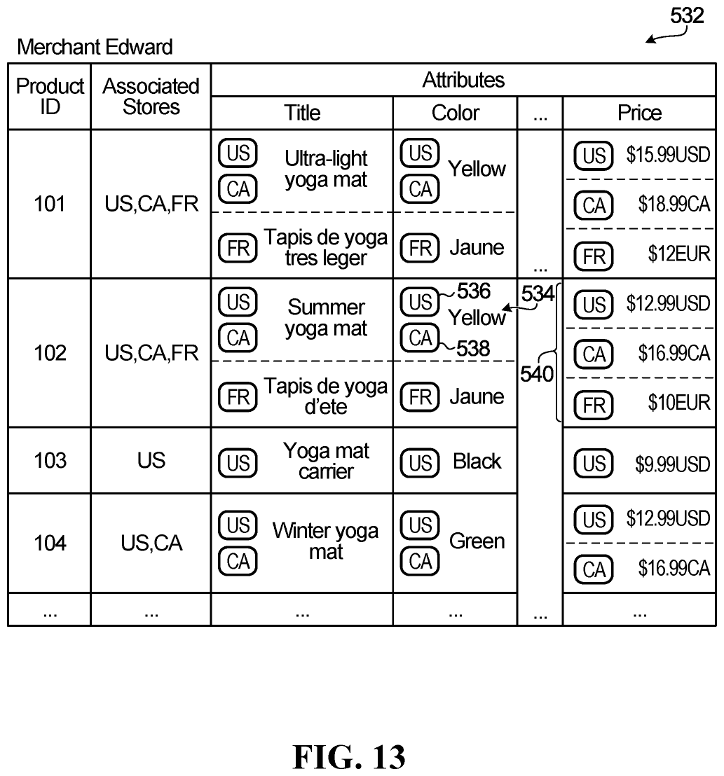

FIG. 13 illustrates an alternative to FIG. 11. FIG. 13 is a global data model implemented as a table 532 that stores the relevant attribute values themselves, rather than just an indication of which attributes are the same or different. In actual implementation the stored data in table 532 may not be stored in a table format. The table 532 in FIG. 13 includes a separate memory allocation (described and illustrated as a row) for each product offered for sale by Merchant Edward in any one or more of the stores associated with Merchant Edward's account. Each row is assigned a product ID and corresponds to one product. For a same product sold across multiple stores, attributes that are the same are collapsed into a single field in memory, possibly with a tag indicating the stores to which the field applies. For example, the summer yoga mat product is offered for sale by Merchant Edward across all three of his stores. This product is assigned product ID 102 in table 532. The product color (“yellow”) is the same for both the U.S. and Canada store, and so is stored in a single field (shown at 534) in association with two tags in memory: a U.S. tag 536 and a Canada tag 538. This indicates that the attribute ‘color=yellow’ applies to both the U.S. and Canada store. The attribute ‘color=yellow’ may be considered a global attribute because it is a single attribute associated with a same product across more than one store. On the other hand, the attribute “price” is different for each store and is therefore not a global attribute. The three different prices are stored separately and tagged with the appropriate store, as shown at 540. The attribute data stored in the global data model itself may be retrieved from memory and transmitted to merchant device 320 for the processor 322 of the merchant device 320 to display on the user interface 326 of the merchant device 320.

Merchant UIs that Utilize the Global Data Model

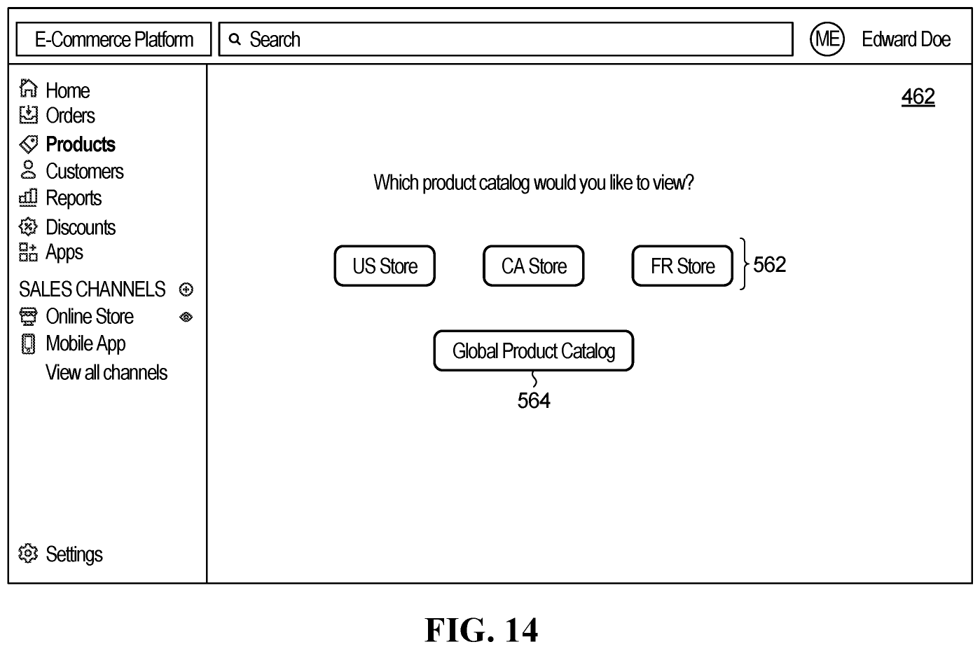

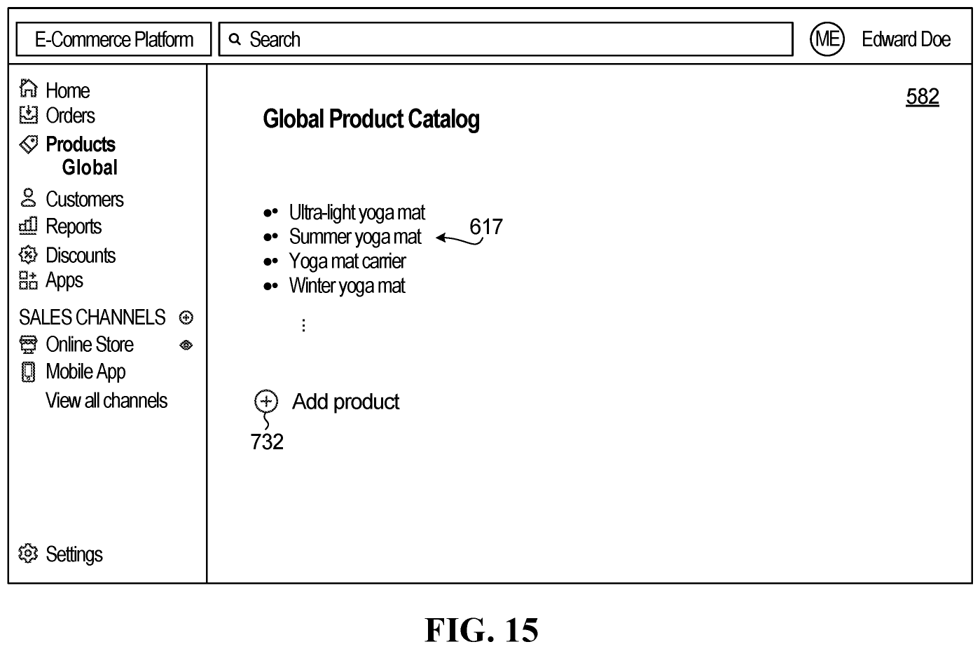

FIG. 14 illustrates an alternative to the administrator web page 462 of FIG. 8. The webpage is generated by the processor 314 of product data engine 310 and transmitted to Merchant Edward's merchant device 320 for presentation on the user interface 326 of the merchant device 320. There is still an option to enter (e.g. log into) any one of Merchant Edward's stores by selecting the appropriate input object (e.g. button), as shown at 562. However, there is also an option to view the global catalog of products by instead selecting input object (e.g. button) 564 on the web page 462. Assuming Merchant Edward selects to enter the global catalog of products, FIG. 15 illustrates a web page 582 specific to the global catalog that retrieves and displays the list of products each indicated (by a unique global product ID) in the left-most column of the table of FIG. 11 or FIG. 13, depending upon which global data model is implemented.

The global catalog of products for sale by Merchant Edward are listed in FIG. 15 independent of the store or stores in which the products are sold. Assuming Merchant Edward selects the product ‘Summer Yoga Mat’ 617, then FIG. 16 illustrates a web page 592 specific to the ‘Summer Yoga Mat’ product for sale by Merchant Edward.

The web page 592 in FIG. 16 is one specific example, and for the sake of example it will be assumed that the web page 592 was populated using the global data model 502 of FIGS. 11 and 12, even though the web page 592 could equally be populated using the global data model 532 of FIG. 13 instead.

As shown at 506 of FIG. 12, the global data model table 502 indicates that the summer yoga mat product is sold in all three stores. As shown at 513 of FIG. 12, the global data model table 502 indicates that the image of the product is the same for all three stores. Therefore, the image attribute is retrieved from the store data for only one of the stores and displayed at 607 of FIG. 16. The store from which the image is retrieved may be predetermined in advance, e.g. by the product data engine itself (e.g. based on the primary store associated with the merchant's account) or based on a preferred store indicated by the merchant.

The title of the product is the same for the U.S. and Canada store, but different for the France store, as indicated at 515 of FIG. 12. Therefore, the title attribute value from the France store is retrieved and sent to the merchant device for display, as shown at 609 of FIG. 16, because it is different. The title attribute value from only one of the U.S. store or the Canada store is retrieved and sent to the merchant device for display, as shown at 611 of FIG. 16, because the title is the same in the U.S. and Canada stores.

The price of the product is different for each store, as indicated at 512 of FIG. 12, and so the price attribute is retrieved from the product data for each store and displayed, as shown at 610.

In some embodiments, tags may be displayed indicating the stores to which the attribute values apply, e.g. tags 606 in FIG. 16. However, a tag might not be displayed if the attribute value is the same for all stores. For example, the image of the item illustrated at 607 of FIG. 16 is the same image for the U.S., Canada, and France store and so is displayed without a tag.

In the example of FIG. 16, the attribute ‘image of item’ is completely collapsed into a single entry because the attribute is the same for each store. The attribute ‘colour of item’ is partially collapsed (showing the two colors—English for the U.S. and CA store, and French for the FR store). The attribute ‘price’ is not collapsed at all (i.e. it is separated out per store), but the three prices are aggregated in one place for presentation on the merchant user interface, as shown at 610.

In some embodiments, the merchant may make changes to attributes at the global level, e.g. by selecting the ‘Edit attributes’ input object (button) 612 in FIG. 16. If the global data model is implemented in the manner explained earlier in relation to FIG. 11, then any change is made directly to the store-level data of FIG. 5, and the stores to which the change applies is indicated from the relationships stored in the global data model of FIG. 11. For example, if the merchant replaces the image 607 with a new image, the processor 314 of the product data engine 310 determines from the table 502 of FIG. 11 that the image attribute is the same for all three stores, and so the processor 314 of the product data engine 310 updates the image attribute in each of tables 360, 362, and 364 of FIG. 5. As another example, if the merchant changes the color in English from “yellow” to “cream”, the processor 314 of the product data engine 310 determines from the table 502 of FIG. 11 that the color attribute is the same for just the U.S. and Canada stores, and so the processor 314 of the product data engine 310 updates the color attribute in each of tables 360 and 362, of FIG. 5, but not table 364 of FIG. 5.

When the global data model is implemented in the manner shown in FIG. 13 (i.e. attribute data is separately stored), then the following embodiments are applicable. In some embodiments, any change made to the global-level attribute data stored in table 532 of FIG. 13 may be automatically pushed down to the product-level product data by the processor 314 of the product data engine 310. For example, if the merchant modifies the attribute ‘color=yellow’ in FIG. 14 to ‘color=cream’, the modification is made at field 534 in FIG. 13 in the product data engine 310. The processor 314 of the product data engine 310 receives an indication that the modification has been made in the global-level attribute data and then may automatically make the same modification in the corresponding store-level data, i.e. at field 632 of table 360 of FIG. 5 and at field 634 of table 362 of FIG. 5. In some embodiments, if a product attribute is modified at the store level, the processor 314 of the product data engine may automatically modify the same product attribute at the global level, e.g. as soon as the modification happens at the store level, or on demand in response to a trigger, e.g. when a request is received to display the global product collection (e.g. when the merchant clicks button 564 of FIG. 14). For example, if the processor 314 of the product data engine 310 automatically decrements the inventory count of the ‘summer yoga mat’ product in the U.S. store due to a sale of the product in the U.S. store, the inventory may also be decremented in the global-level data stored in table 532 of FIG. 13. In this way, the global data model 332 and the store-level product data 330 may be stored independent of each other, but kept in synchronization so that the product data is consistent at the store level and the global level. Alternatively, in some embodiments, the global-level product attribute information in FIG. 13 may be modified without modifying the store-level product data, which is possible if the global-level product attribute information is stored independent from the store-level product data, like is the case in FIG. 13 (but not in FIG. 11).

In some embodiments, a merchant may define a master product or store for a set of products that have been matched together. A master product or store may alternatively be referred to as a global product or store, a main product or store, or a default product or store. Any change made to an attribute in the master product or store may be automatically propagated to the other stores selling that product, as appropriate. For example, in FIG. 16 the product title is displayed in bold at the top of the screen as ‘Summer Yoga Mat’, as shown at 615, and is also displayed as the title of the product in the global catalog product collection view at 617 of FIG. 15. This is the title of the product in the U.S. store. Instead, the master product/store may be set as the summer yoga mat for sale in the France store, in which case the title shown at 615 of FIGS. 16 and 617 of FIG. 15 would instead read Tapis de yoga d'été'.

In some embodiments, FIG. 16 may be modified so that by default it only shows the attributes associated with the master store. A link may also be displayed that, when selected, further modifies the webpage to additionally show the corresponding attributes associated with the same product for sale in the other stores. In one example, if the master store is the U.S. store, the attribute ‘color=jaune’ is not displayed in FIG. 16 because it is a corresponding attribute associated with the product in another store different from the master store. Clicking on a link may modify the webpage to reveal the corresponding attribute ‘color=jaune’. Alternatively, hovering the cursor over an attribute shown in the master store may show the corresponding attribute value for each of the other stores in which the product is offered for sale.

In some embodiments, a master product/store may be selected manually by the merchant or determined automatically, e.g. based on the location of the merchant, language preferences of the merchant, sales metrics (e.g. master store is the one that sells the greatest number of product), etc.

In some embodiments, a merchant may use the global-level product view to add or remove products. For example, input object (e.g. button) 732 in FIG. 15 may be selected by the merchant to allow the merchant to add a new product. The process of adding the new product involves transmitting a message to the merchant device asking the merchant to indicate the stores on which the new product is to be sold. The product attributes of the new product that are defined at the global-level are then propagated to the store level for storage in the appropriate table(s) of FIG. 5, and the relationships stored in the table of FIG. 11 are populated or updated as needed.

In some embodiments, once a set of products has been matched, inventory may be taken from one store when another store is out of stock. For example, if the ‘Summer Yoga Mat’ is identified as a same product for sale in both the U.S. and Canada store, and if the Canada store is out of inventory of the ‘Summer Yoga Mat’, but the U.S. store is not, then when a unit of the ‘Summer Yoga Mat’ is purchased on the Canada store a unit may be taken and shipped from the U.S. store. This embodiment might only be enabled in certain scenarios, e.g. where the vendor and shipping location is the same for the product for the two stores.

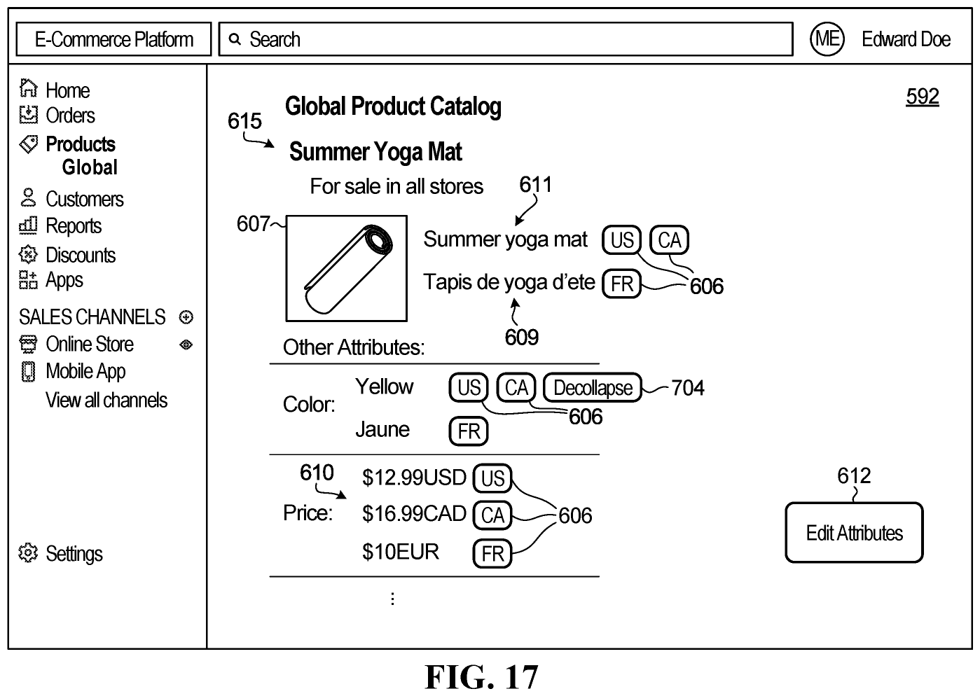

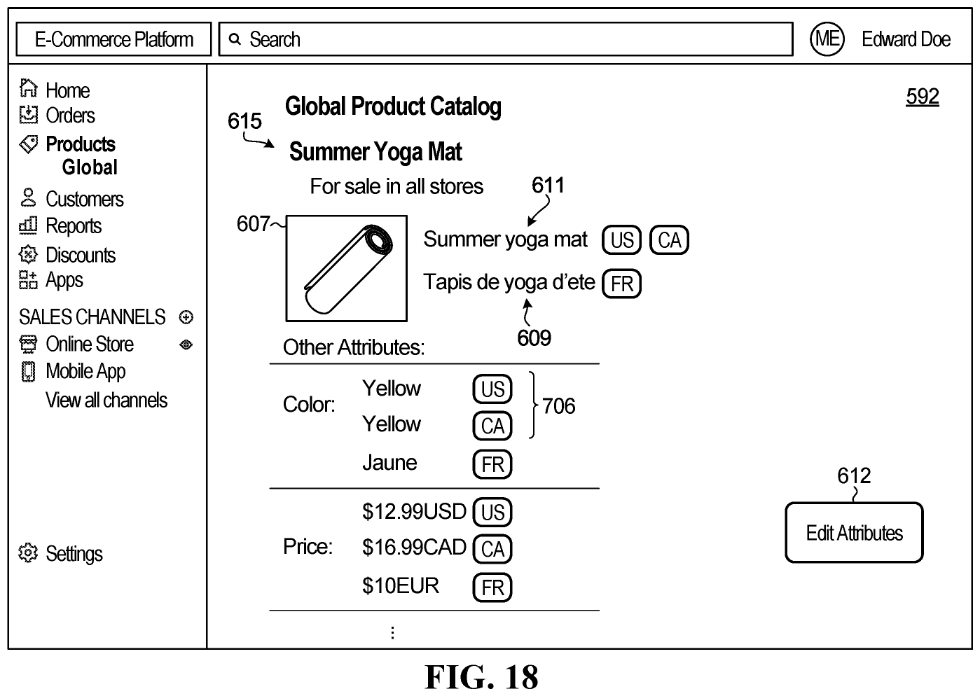

In some embodiments, the merchant may be able to de-collapse (i.e. expand) fields collapsed in the global-level view of a product. For example, FIG. 17 illustrates FIG. 16, but with an additional input object 704 (e.g. button) that, when selected de-collapses the partially collapsed attribute ‘color=yellow’ to result in the presentation shown at 706 of FIG. 18. In other embodiments, the de-collapsing functionality may not be available, and/or there may not be functionality to have a tag to indicate which stores a particular global attribute is associated with. The absence of tagging (e.g. the absence of tags 606 of FIG. 16) and/or the absence of collapse/de-collapse functionality (e.g. the absence of button 704 of FIG. 17) is more limiting. The technical upside is possibly saving memory space in the storage of the global data model 332.

In some embodiments, the global-level view of the product collection may be viewed and filtered by different characteristics of underlying stores, e.g. only show products from the Canada store, only show products from English-speaking stores, etc. In some embodiments, in the global-level view the processor 314 may group variants together across stores, e.g. brown and black boots stored as a single entry referred to as ‘boots’.

In some embodiments, the merchant may be able to disable the global product-level view, depending upon the preference of the merchant. For example, disabling the global product-level view may revert the webpage in FIG. 14 back to the webpage in FIG. 8.

### Product Matching Algorithm

Returning to FIG. 4, to generate the global data model 332 (e.g. to create tables 502 or 532 of FIGS. 11-13), the processor 314 must determine which products in the merchant's collection are the same across different stores. In some embodiments, this information may be provided by the merchant, e.g. the merchant explicitly indicates that the product titled “summer yoga mat” and separately offered for sale in the U.S., Canada, and France store is the same product. In other embodiments, product matching is done by the processor 314 automatically, optionally with some merchant input. Example ways of product matching are described below. The product matching may be performed by a product matching algorithm.

In some embodiments, two products are matched if each of their corresponding attributes are exactly the same. In some embodiments, two products are matched if one or more particular corresponding attributes are exactly the same, e.g. if the SKU number of the two products are exactly the same. In some embodiments, two products are matched if certain corresponding attributes, a number of certain corresponding attributes, and/or a certain percentage of corresponding attributes are an exact match, e.g. if the title, description, and color are an exact match for two products sold in respective different stores.

In some embodiments, a first product is selected from a first catalog of a first store. The algorithm then traverses each product in each catalog of each other store and assigns a score to the product based on how similar the attributes of that product are to the selected first product. A score equal to or above a certain threshold (e.g. a score of 95 out of 100 or above, or a number equal to or above a certain threshold of corresponding attributes equal to each other) indicates a match. In some embodiments, a score within a particular range (or below a particular threshold) results in a message being sent to the merchant asking for the merchant to indicate whether the products are a match, e.g. the merchant is asked to confirm the match when the score is in the range 80-95 out of 100. In some embodiments, when corresponding attributes of two different products are similar, the merchant may be presented with an opportunity to confirm whether or not the attributes and/or products are the same. The merchant may also be presented with the opportunity to amend one or both of the corresponding attributes that are similar, e.g. to set them exactly the same. Any amendments made by the merchant to the attributes are reflected in the attribute data stored in memory, e.g. in the tables in FIG. 5. The algorithm continues to try to identify matches for each product in each catalog of each store, with any product previously matched being removed from consideration.

Example ways to score similarity may include:
Count the number of corresponding attributes equal to each other. The score may be proportional to the percentage of attributes equal to each other.
Particular important attributes may have a larger impact (weighting) on the score. For example, if the title and description are exact matches, then there is a large impact on the score because products having the exact same title and description are very likely the same product. Therefore, even though many different corresponding attributes may possibly be compared, the score may be largely dependent upon whether particular important corresponding attributes match.
Corresponding attributes having text entries similar to each other within a particular margin of text difference may contribute positively to the score. For example, if the description of two products differs by one word, then the score is positively impacted, but not as much as when the text values are an exact match.

In some embodiments, the score is computed by only comparing certain corresponding attributes, e.g. title, description, images, colour, SKU, vendor, meta-fields (such as key value pairs defined by a merchant or an application, e.g. yoga mat surface texture).

There may be slight differences between different corresponding attribute values, e.g. due to cultural differences between different countries or due to typographical errors. For example, the title of the product in the U.S. store may be “summer yoga mat”, but the title of the product in the Canada store may be “summer yoga matt” due to a typographical error. As another example, the description of the product in the U.S. store may be exactly the same as the description of the product in the Canada store, except that the description in the Canada store may use “knapsack” instead of “backpack”. Therefore, in some embodiments the scoring method factors in differences between string values of corresponding attributes and computes a higher score if there are only minor differences between the string text of corresponding attributes. The difference between two corresponding attributes that are each represented as strings of text may be computed as the Levenshtein distance. For example, if the title of the product in the U.S. store and the title of the product in the Canada store only differ by one character (e.g. due to a typo in the title of the product in the Canada store), then the Levenshtein distance would be small, which may result in higher score value.

In some embodiments, the product matching algorithm may automatically account for known differences between corresponding attributes in different stores. For example, converting between imperial vs. metric measurements to ensure that the same measurement unit is compared across different stores, e.g. if the product dimension is 1 foot×1 foot for the product in the U.S. store, and the product dimension is 30 cm×30 cm for the product in the Canada store, then the product dimension attribute values may be determined to be equal to each other (since 1 foot approximately converts to 30 cm). As another example, currency conversion may be applied to ensure a consistent currency is being compared across different stores. As another example, machine translation of language may be applied to ensure a consistent language is being compared across different stores, e.g. the title of the product in the France store is converted to English and then compared to the title of the product in the U.S. store.

In some embodiments, a score may be computed at a product listing level, e.g. the likelihood that product ID 002 in store #1 in FIG. 5 is equal to product ID 003 in store #2 in FIG. 5 is 90%. Additionally, or instead, a score may be computed at the attribute value/field level, e.g. the likelihood that the title of product ID 002 in store #1 in FIG. 5 is equal to the title of product ID 003 in store #2 in FIG. 5 is 100%. Determining and storing scores at the individual attribute value/field level may allow for collapsing certain attributes that are the same, e.g. if the title of the product in the U.S. and Canada store is determined to be the same because of a high score, then only the title value for one of those stores is sent to the merchant device for display, as shown at 611 of FIG. 16.

In some embodiments, a score value of 0.8 (80%) or higher is considered a match, i.e. the corresponding attribute values or corresponding products are considered to be the same. In some embodiments, a score value of 0.6 (60%) or lower is considered not to be a match, i.e. the corresponding attribute values or corresponding products are considered to be different. In some embodiments, a score between 0.6 and 0.8 (60%-80%) results in a prompt being sent to the merchant requesting that the merchant confirm or decline the match.

In some embodiments, the product matching algorithm may be implemented as follows: the SKU (or other product ID) is used as a “hard” requirement, e.g. find all matching SKUs. For example, if the SKU of a product for sale in one store is the same as the SKU for a product for sale in another store, then determine that the two products are the same.

In some embodiments, the product matching algorithm may also or instead implement the following operations:
The difference between some or all corresponding attributes is recorded, and if the number of same attributes is above a threshold X, then determine that the products match.
Allow the merchant to configure the matching algorithm. For example, a configuration provided by the merchant may include: match two products in two different stores when SKU1=SKU2 or when (Title1=Title2, AND VariantCount1=VariantCount2), where Variant Count is the number of product variants that the product has.
Allow the merchant to configure progressive matching rules, e.g.: first pass match based on SKU only; second pass match based on additional rules, e.g. if (SKU or Title) equals the same then match; third pass find products that have a matching score between 60%-80% and request merchant to confirm whether or not products are the same.

The merchant may configure other parameters in addition to or instead of the parameters of the matching algorithm. For example, the merchant may indicate which attributes of which product are displayed in the global product view, e.g. as discussed earlier in relation to FIG. 16. For example, the merchant may indicate that the title of the U.S. store is to be displayed in the global product view. As another example, the merchant may configure, for two matching products, which attributes (if any) are changed to match the merchant's master store. For example, a product for sale in the U.S. store may be matched with a product for sale in the Canada store. The merchant may indicate that upon such a match, all of the attribute values from the Canada store are to be set equal to the corresponding attribute values in the U.S. store, except for the price, inventory, and vendor.

### Methods

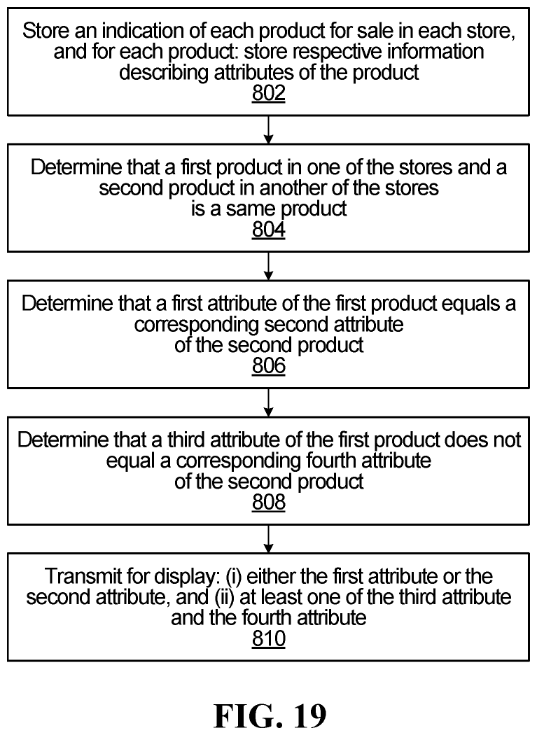

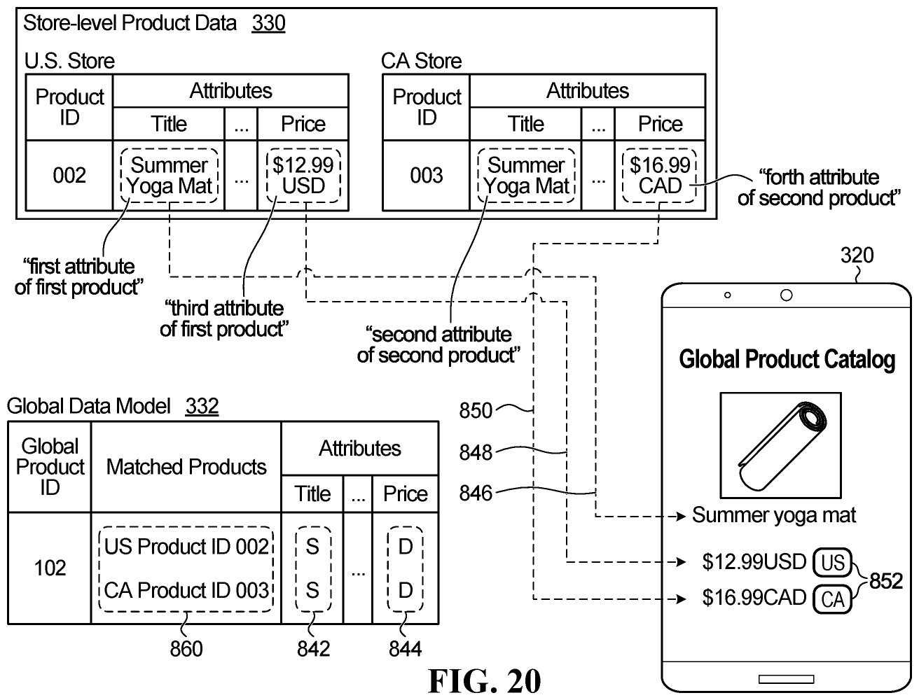

FIG. 19 illustrates a computer-implemented method, according to one embodiment. The method may be performed by a computing device (e.g. a processor or combination of processors such as the processor 314 in product data engine 310). The computing device may be in an e-commerce platform. The method will be described as being performed in product data engine 310 of FIG. 4, but this is not necessary. Also, the method will be described with reference to FIG. 20, which illustrates example store-level product data 330, global data model 332, and merchant device 320 for a particular merchant.

At step 802 of FIG. 19, for each store of a plurality of stores associated with a merchant account: the processor 314 stores in memory an indication of each product for sale in the store, and for each product stores respective information describing attributes of the product. An example is store-level product data 330, e.g. that illustrated in FIG. 5. Another example is store-level product data 330 illustrated in FIG. 20, which illustrates some of the stored store-level data for a U.S. store and a Canada store for a merchant. Product ID 002 of the U.S. store and Product ID 003 of the Canada store are illustrated, along with some example attributes corresponding to that product in each store. Only the “title” and “price” attributes are illustrated. The title of the two products is the same, but the price is different.

Note that step 802 of FIG. 19 is optional if the method instead begins at step 804.

At step 804 of FIG. 19, the processor 314 determines that a first product in one of the plurality of stores and a second product in another of the plurality of stores are a same product. Example ways in which two products in different stores are determined to be the same are described earlier, e.g. when describing the product matching algorithm. For example, if one of the corresponding attributes of the two products is an exact match (e.g. the SKU is an exact match), then the first and second products may be determined to be the same product. For example, in FIG. 20 product ID 002 of the U.S. store is determined to be the same as product ID 003 of the CA store, e.g. because the titles are an exact match.

At step 806 of FIG. 19, a first attribute of the first product is compared to a corresponding second attribute of the second product, and the processor 314 determines that the first attribute equals the second attribute. This information may be stored in memory, e.g. in global data model 332. For example, in FIG. 20 the “first attribute of the first product” is the title of product ID 002 of the U.S. store, and the “corresponding second attribute of the second product” is the title of product ID 003 of the Canada store. The two attributes are corresponding because they are both title attributes. The title of the two products is the same (i.e. the corresponding attribute values equal each other), and this is indicated in the global data model at 842.

At step 808, a third attribute of the first product is compared to a corresponding fourth attribute of the second product, and the processor 314 determines that the third attribute does not equal the fourth attribute. This information may also be stored in memory, e.g. in global data model 332. For example, in FIG. 20 the “third attribute of the first product” is the price of product ID 002 of the U.S. store, and the “corresponding fourth attribute of the second product” is the price of product ID 003 of the Canada store. The two attributes are corresponding because they are both price attributes. The price of the two products is different (i.e. the corresponding attribute values do not equal each other), and this is indicated in the global data model at 844.

At step 810, the processor 310 instructs that the following be transmitted through network interface 312 and over the network 318 to merchant device 320, for display on the merchant device 320: (i) either the first attribute or the second attribute; and (ii) at least one of the third attribute and the fourth attribute. For example, in FIG. 20 the first attribute (i.e. the title of the product from the U.S. store data) is transmitted to the merchant device 320 for display, as shown at 846. The second attribute (i.e. the title of the product from the Canada store data) is not transmitted to the merchant device 320 because it equals the first attribute and so only one needs to be transmitted and displayed. The second attribute could have been transmitted for display instead of the first attribute. In some embodiments, whether the first attribute or the second attribute is transmitted for display may depend upon a setting in the e-commerce platform (and/or in the product data engine 310). In some embodiments, whether the first attribute or the second attribute is transmitted for display may be configured by the merchant. For example, if the U.S. store is registered as the merchant's primary store in an e-commerce platform, then the attributes from the U.S. store may be transmitted to the merchant device and displayed whenever there are corresponding equal attributes across the different stores.

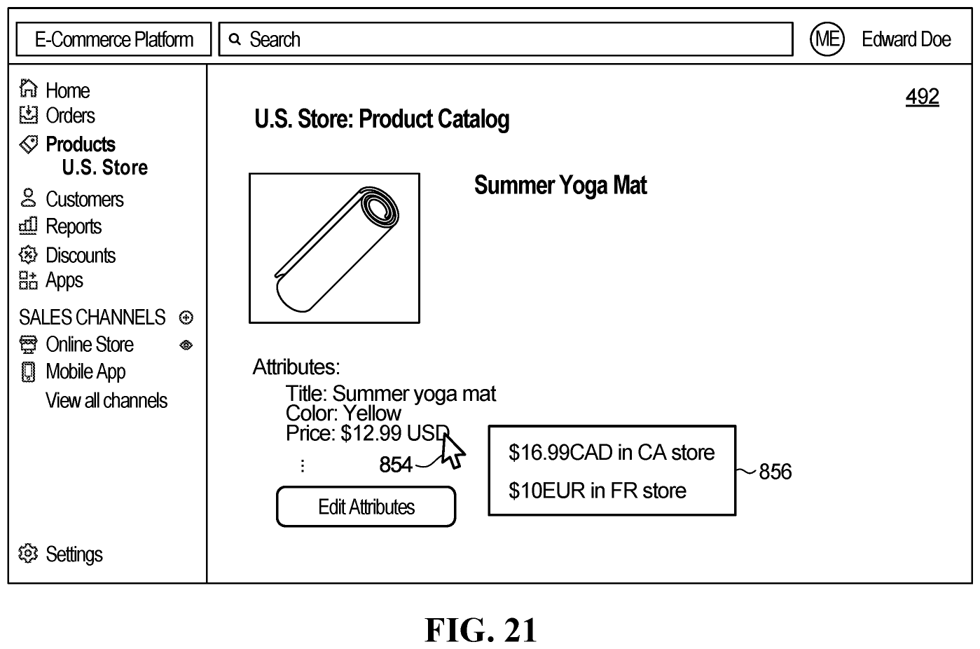

In FIG. 20, both the third attribute (i.e. the price of the product from the U.S. store data) and the fourth attributed (i.e. the price of the product from the Canada-specific store data) are transmitted to the merchant device 320 for display, as shown at 848 and 850. Both are transmitted and displayed because the corresponding attributes (i.e. the corresponding prices) are different. A tag may be displayed indicating which price corresponds to which store, as shown at 852. Although both prices are transmitted and displayed, this may not always be the case, e.g. if the default merchant user interface shows a view in which only attributes from one store (e.g. the U.S. store) are displayed. For example, FIG. 21 illustrates the merchant user interface of FIG. 10 in which the U.S. product is displayed with only its attributes. However, if the merchant hovers a cursor over a particular attribute, then the other corresponding different attribute values in different stores are shown. For example, in FIG. 21 the cursor 854 hovers over the price, which causes box 856 to pop up and show the corresponding different prices for that same product in the merchant's other stores.

In some embodiments of the method of FIG. 19, both the third attribute and the fourth attribute are transmitted for display on the merchant device (e.g. as shown at 848 and 850 of FIG. 20). In some of such embodiments, the method may further include instructing the merchant device to display the third attribute and the fourth attribute concurrently with an indication that the third attribute and the fourth attribute are corresponding attributes associated with respective different stores. An example is tags 852 of FIG. 20, which indicate that the prices are corresponding attributes respectively associated with the U.S. and Canada stores.

In some embodiments, a plurality of attributes of the first product are transmitted to the merchant device for display on the merchant device, where the plurality of attributes include the first attribute. In some such embodiments, the method may further include: receiving a message from the merchant device, the message instructing a modification to the fourth attribute of the second product; in response to receiving the message: amending the fourth attribute of the second product to reflect the modification. For example, in FIG. 21 the attributes of the U.S. store are displayed, including the title of the product in the U.S. store (i.e. including the “first attribute”). However, pop-up box 856 shows the corresponding prices from the other stores. The merchant may edit the price $16.99 CAD for the Canada store (i.e. the merchant may edit the “fourth attribute”), e.g. by selecting the price and editing it through the merchant user interface. This causes the attribute to be modified in the store-level data. For example, if the merchant changes the price from $16.99 CAD to $15.99 CAD, then the “fourth attribute of the second product” in the store-level product data 330 in FIG. 20 is modified from $16.99 to $15.99. In this way, the merchant can primarily view the attributes of their primary store (e.g. the U.S. store, as shown in FIG. 21), but can still view and modify one or more attributes of the same product in their other stores in which that same product is offered for sale.

In some embodiments, amending the fourth attribute of the second product to reflect the modification results in an amended fourth attribute, and the method further includes: comparing the third attribute of the first product to the amended fourth attribute of the second product and determining that the third attribute equals the amended fourth attribute; transmitting, to the merchant device for display on the merchant device, either the third attribute or the amended fourth attribute. For example, if the merchant modifies the price of the product in the Canada store (the “fourth attribute”) to be $12.99 instead of $16.99, then the price of the product in the U.S. and Canada store are now equal ($12.99 each), and as a result only one of the two attributes needs to be displayed because they are equal. For example, the user interface of the merchant device 320 in FIG. 20 may modify to only show the $12.99 price, which may be obtained from the U.S. store data or the Canada store data.

In some embodiments, a plurality of attributes of the first product are transmitted to the merchant device for display on the merchant device, the plurality of attributes including the first attribute, and the method further includes: receiving a message from the merchant device, the message instructing a modification to the first attribute to result in an amended first attribute of the first product; and in response to the amended first attribute of the first product being different from the second attribute of the second product: transmitting, to the merchant device for display on the merchant device, the amended first attribute of the first product and the second attribute of the second product. For example, the user interface of the merchant device 320 in FIG. 20 illustrates display of the first attribute “Summer Yoga Mat” from the U.S. store data, as shown at 846. The merchant may select the title on the user interface and modify it, e.g. to read “Sunshine Yoga Mat”. The title is updated in the store-level product data 330 for the U.S. store. The title of the product in the U.S. and Canada stores is now different, i.e. the “amended first attribute of the first product” (Sunshine Yoga Mat) is different from the “second attribute of the second product” (Summer Yoga Mat). In response, the merchant device user interface may be updated to show both titles.

In some embodiments, the first attribute, and not the second attribute, is transmitted to the merchant device for display on the merchant device, and the method further includes: receiving a message from the merchant device, the message instructing a modification to the first attribute of the first product; and in response to receiving the message: amending the first attribute of the first product to reflect the modification and also amending the second attribute of the second product to reflect the modification. For example, the user interface of the merchant device 320 in FIG. 20 illustrates display of the first attribute “Summer Yoga Mat” from the U.S. store data, at shown at 846. The merchant may select the title on the user interface and modify it, e.g. to read “Sunshine Yoga Mat”. The title is updated in the store-level product data 330 for both the U.S. store and the Canada store. That is, the titles of the product in the two stores remain equal to each other, but both modified to be “Sunshine Yoga Mat”. In this way, the merchant can more easily update the title of the same product across multiple stores.

In some embodiments, the method includes storing in memory: an indication that the first product and the second product are the same product (e.g. as shown at 860 of FIG. 20); and for each attribute of a plurality of attributes of the first product: an indication of whether the attribute is the same as a corresponding attribute of the second product (e.g. as shown at 842 of FIG. 20).

In some embodiments, for each set of attributes comprising a particular attribute of the first product and a corresponding particular attribute of the second product, the method includes: (i) transmitting only one attribute from the set of attributes to the merchant device for display when there is stored in the memory an indication that all attributes in the set of attributes are the same (e.g. as per 846 of FIG. 20 in which only the title from the U.S. store is displayed); and (ii) transmitting each attribute from the set of attributes to the merchant device for display when there is no indication stored in the memory that all attributes in the set of attributes are the same (e.g. as per 848 and 850 of FIG. 20 in which both prices are displayed).

In some embodiments, the determining that the first product and the second product are a same product in step 804 of FIG. 19 includes: comparing a particular attribute of the first product to a corresponding particular attribute of the second product, and determining that the first product and the second product are the same product based on the comparing. In some such embodiments, it may be determined that the particular attribute of the first product is equal to the corresponding particular attribute of the second product, and it is then determined that the first product and the second product are the same product at least based on the particular attribute of the first product being equal to the corresponding particular attribute of the second product. For example, the first product (in the U.S. store) and the second product (in the Canada store) may be determined to be the same product because they have the same title “Summer Yoga Mat”. As another example, the two products may be determined to be the same product because they have the same SKU. That is, in one embodiment the particular attribute of the first product is a SKU of the first product, and the corresponding particular attribute of the second product is a SKU of the second product.

In some embodiments, for each attribute of one or more attributes of the first product, the method includes: comparing the attribute to a corresponding attribute of the second product, and based on the comparing generating or updating a score value measuring a likelihood that the first product and the second product are the same product. In some such embodiments, determining that the first product and the second product are the same product includes determining that the score value passes a predetermined threshold. Example scoring methods are described earlier. In some embodiments, when the score value passes the predetermined threshold, but is still within a particular range, then the method further includes: transmitting a message to the merchant device, the message querying whether the first product and the second product are the same product, and wherein determining that the first product and the second product are the same product further includes receiving a response to the message from the merchant device, the response confirming that the first product and the second product are the same product. For example, if the score value is within a certain range (e.g. 60%-80% confidence), then a message is transmitted to the merchant device querying whether the two products are the same. The two products are identified as the same if the merchant replies confirming that they are the same.

In some embodiments, a system to perform the method of FIG. 19 is provided. The system may include a memory (e.g. memory 316 of FIG. 4) and at least one processor (e.g. processor 314 of FIG. 4). The memory stores the indications and information, and the at least one processor directly performs or instructs operations. For example, the at least one processor may directly perform certain operations such as determining whether two products are the same (e.g. via the product matching methods described herein), comparing corresponding attributes of same products, and updating the store-level data and global data model. The at least one processor may instruct certain operations, e.g. instruct that particular information (e.g. attributes) be transmitted to a merchant device. This may occur by the processor retrieving the information to be transmitted and any associated instructions for the merchant device (e.g. instructions indicating how the information is to be displayed), and then sending an instruction to a transmitter to transmit the information and associated instructions to the network address (e.g. IP address) of the merchant device. The transmission is sent through a network interface and over a network and to the merchant device.

### Other Use Cases for Product Matching

The preceding embodiments are all described in the context of product matching within a single merchant account. For a particular merchant, the product matching algorithm traverses each of that merchant's product catalogs for each of that merchant's stores to identify a same product across two or more of that merchant's stores. However, the product matching methods described herein are also applicable to other scenarios and use cases, including situations in which the same or similar products are identified across different stores of different merchant accounts.

As one example, the product matching methods described herein may be used to determine whether different merchants happen to be selling the same product or a similar product. For a particular product category, the product matching algorithm may traverse each product catalog of every merchant on the commerce platform and identify product matches across different merchant accounts. For example, if merchant Fred is selling a pineapple keychain and merchant Edward is also selling a pineapple keychain, these products may be matched, even though merchant Fred and merchant Edward are independent merchants having no relationship with each other, other than that they are both merchants on the platform. The knowledge gained from identifying the same or similar products across different merchants on the platform may be used for different purposes, e.g. to track how many of a certain type or category of product is being sold on the platform, which may be used to identify trends. As another example, the knowledge may be used to connect different merchants selling the same or similar products, or to provide sales leads to certain merchants (e.g. connecting one merchant that sells the product in bulk to another merchant that sells individual units of the product, so that the merchant that sells the product in bulk may reach out and possibly sell to the other merchant that sells individual units of the product). More generally, the information identifying the same or similar products may be surfaced to any interested party depending upon the use case, e.g. the information may be surfaced to product suppliers, and/or merchants, and/or the administrator running the commerce platform, etc.

In some of the use cases described above, it might be the case that only similar products need to be identified, not necessarily products that are known with certainty or high confidence to be the same product. For example, a first product sold by a first merchant may be a pineapple keychain with a particular title “Pineapple Keychain”, a particular price “$5 USD”, a particular product image, etc. A second product sold by a second merchant may be a banana keychain with a particular title “Banana Keychain”, a particular price “$4 USD”, a particular product image, etc. The product matching algorithm may generate a score in the manner described earlier. The score may be within a particular range that indicates that although the products are likely not an exact match, the products are similar. Two products may be considered “similar” when the score is within a particular range of confidence, e.g. between 50%-80%. The fact that the pineapple keychain and banana keychain have some similar attributes (e.g. the word “keychain” appears in each product title and the price is similar) results in a matching score with a high enough confidence to conclude that the products are similar.

In some embodiments, the image of the product may be used to assist in determining whether two products are similar or the same. Embodiments are described earlier in which the product image for two products is determined to be the same if the hash of each image is equal. However, the same product sold by two different merchants would likely not have the same product image, although the two images would likely have similarities. Likewise, two different products that are similar to each other would have different product images, but the product images would likely have similarities. Therefore, in some embodiments, the product matching algorithm incorporates into its matching score a measure of similarity between images of products sold by different merchants, e.g. through image recognition, colour histogram comparisons, etc.

### CONCLUSION

Although the present invention has been described with reference to specific features and embodiments thereof, various modifications and combinations can be made thereto without departing from the invention. The description and drawings are, accordingly, to be regarded simply as an illustration of some embodiments of the invention as defined by the appended claims, and are contemplated to cover any and all modifications, variations, combinations or equivalents that fall within the scope of the present invention. Therefore, although the present invention and its advantages have been described in detail, various changes, substitutions, and alterations can be made herein without departing from the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

Moreover, any module, component, or device exemplified herein that executes instructions may include or otherwise have access to a non-transitory computer/processor-readable storage medium or media for storage of information, such as computer/processor-readable instructions, data structures, program modules, and/or other data. A non-exhaustive list of examples of non-transitory computer/processor-readable storage media includes magnetic cassettes, magnetic tape, magnetic disk storage or other magnetic storage devices, optical disks such as compact disc read-only memory (CD-ROM), digital video discs or digital versatile disc (DVDs), Blu-ray Disc™, or other optical storage, volatile and non-volatile, removable and non-removable media implemented in any method or technology, random-access memory (RAM), read-only memory (ROM), electrically erasable programmable read-only memory (EEPROM), flash memory or other memory technology. Any such non-transitory computer/processor storage media may be part of a device or accessible or connectable thereto. Any application or module herein described may be implemented using computer/processor readable/executable instructions that may be stored or otherwise held by such non-transitory computer/processor-readable storage media.

1. A computer-implemented method comprising:
for each store of a plurality of stores associated with a merchant account: storing an indication of each product for sale in the store, and for each product storing respective information describing attributes of the product;
determining that a first product in one of the plurality of stores and a second product in another of the plurality of stores are a same product;
comparing a first attribute of the first product to a corresponding second attribute of the second product and determining that the first attribute equals the second attribute;
comparing a third attribute of the first product to a corresponding fourth attribute of the second product and determining that the third attribute does not equal the fourth attribute;
transmitting, to a merchant device for display on the merchant device: (i) either the first attribute or the second attribute; and (ii) at least one of the third attribute and the fourth attribute.

2. The computer-implemented method of claim 1, wherein both the third attribute and the fourth attribute are transmitted for display on the merchant device, and further comprising instructing the merchant device to display the third attribute and the fourth attribute concurrently with an indication that the third attribute and the fourth attribute are corresponding attributes associated with respective different stores.

3. The computer-implemented method of claim 2, wherein a plurality of attributes of the first product are transmitted to the merchant device for display on the merchant device, the plurality of attributes including the first attribute, and wherein the method further comprises:
receiving a message from the merchant device, the message instructing a modification to the fourth attribute of the second product;
in response to receiving the message: amending the fourth attribute of the second product to reflect the modification.

4. The computer-implemented method of claim 3, wherein amending the fourth attribute of the second product to reflect the modification results in an amended fourth attribute, and wherein the method further comprises:
comparing the third attribute of the first product to the amended fourth attribute of the second product and determining that the third attribute equals the amended fourth attribute;
transmitting, to the merchant device for display on the merchant device, either the third attribute or the amended fourth attribute.

5. The computer-implemented method of claim 1, wherein a plurality of attributes of the first product are transmitted to the merchant device for display on the merchant device, the plurality of attributes including the first attribute, and wherein the method further comprises:
receiving a message from the merchant device, the message instructing a modification to the first attribute to result in an amended first attribute of the first product;
in response to the amended first attribute of the first product being different from the second attribute of the second product: transmitting, to the merchant device for display on the merchant device, the amended first attribute of the first product and the second attribute of the second product.

6. The computer-implemented method of claim 1, wherein the first attribute, and not the second attribute, is transmitted to the merchant device for display on the merchant device, and wherein the method further comprises:
receiving a message from the merchant device, the message instructing a modification to the first attribute of the first product;
in response to receiving the message: amending the first attribute of the first product to reflect the modification and also amending the second attribute of the second product to reflect the modification.

7. The computer-implemented method of claim 1, further comprising storing in memory:
an indication that the first product and the second product are the same product; and
for each attribute of a plurality of attributes of the first product: an indication of whether the attribute is the same as a corresponding attribute of the second product;
and wherein for each set of attributes comprising a particular attribute of the first product and a corresponding particular attribute of the second product:
(i) transmitting only one attribute from the set of attributes to the merchant device for display when there is stored in the memory an indication that all attributes in the set of attributes are the same; and
(ii) transmitting each attribute from the set of attributes to the merchant device for display when there is no indication stored in the memory that all attributes in the set of attributes are the same.

8. The computer-implemented method of claim 1, wherein determining that the first product and the second product are a same product comprises: comparing a particular attribute of the first product to a corresponding particular attribute of the second product, and determining that the first product and the second product are the same product based on the comparing.

9. The computer-implemented method of claim 8, comprising determining that the particular attribute of the first product is equal to the corresponding particular attribute of the second product, and determining that the first product and the second product are the same product based on the particular attribute of the first product being equal to the corresponding particular attribute of the second product.

10. The computer-implemented method of claim 9, wherein the particular attribute of the first product is a stock keeping unit (SKU) of the first product, and wherein the corresponding particular attribute of the second product is a SKU of the second product.

11. The computer-implemented method of claim 1, wherein for each attribute of one or more attributes of the first product, the method comprises: comparing the attribute to a corresponding attribute of the second product, and based on the comparing generating or updating a score value measuring a likelihood that the first product and the second product are the same product; and wherein determining that the first product and the second product are the same product comprises determining that the score value passes a predetermined threshold.

12. The computer-implemented method of claim 11, wherein when the score value passes the predetermined threshold, but is still within a particular range, then the method further comprises: transmitting a message to the merchant device, the message querying whether the first product and the second product are the same product; and wherein determining that the first product and the second product are the same product further comprises receiving a response to the message from the merchant device, the response confirming that the first product and the second product are the same product.

13. A system comprising:
a memory to store an indication of each product for sale in each store of a plurality of stores associated with a merchant account, and for each product to store respective information describing attributes of the product;
at least one processor to:
determine that a first product in one of the plurality of stores and a second product in another of the plurality of stores are a same product;
compare a first attribute of the first product to a corresponding second attribute of the second product and determine that the first attribute equals the second attribute;
compare a third attribute of the first product to a corresponding fourth attribute of the second product and determine that the third attribute does not equal the fourth attribute;
instruct transmission, to a merchant device for display on the merchant device: (i) either the first attribute or the second attribute; and (ii) at least one of the third attribute and the fourth attribute.

14. The system of claim 13, wherein the at least one processor is to instruct transmission of both the third attribute and the fourth attribute for display on the merchant device, and wherein the third attribute and the fourth attribute are to be displayed concurrently with an indication that the third attribute and the fourth attribute are corresponding attributes associated with respective different stores.

15. The system of claim 14, wherein a plurality of attributes of the first product are to be transmitted to the merchant device for display on the merchant device, the plurality of attributes including the first attribute, and wherein the system is to:
receive a message from the merchant device, the message instructing a modification to the fourth attribute of the second product;
in response to receiving the message: the at least one processor is to amend the fourth attribute of the second product to reflect the modification.

16. The system of claim 15, wherein amending the fourth attribute of the second product to reflect the modification results in an amended fourth attribute, and wherein the at least one processor is further to:
compare the third attribute of the first product to the amended fourth attribute of the second product and determine that the third attribute equals the amended fourth attribute;
instruct transmission, to the merchant device for display on the merchant device, either the third attribute or the amended fourth attribute.

17. The system of claim 13, wherein a plurality of attributes of the first product are to be transmitted to the merchant device for display on the merchant device, the plurality of attributes including the first attribute, and wherein the system is to:
receive a message from the merchant device, the message instructing a modification to the first attribute to result in an amended first attribute of the first product;
in response to the amended first attribute of the first product being different from the second attribute of the second product: the at least one processor is to instruct transmission, to the merchant device for display on the merchant device, the amended first attribute of the first product and the second attribute of the second product.

18. The system of claim 13, wherein the first attribute, and not the second attribute, is to be transmitted to the merchant device for display on the merchant device, and wherein the system is to:
receive a message from the merchant device, the message instructing a modification to the first attribute of the first product;
in response to receiving the message: the at least one processor is to amend the first attribute of the first product to reflect the modification and also amend the second attribute of the second product to reflect the modification.

19. The system of claim 13, wherein the at least one processor is to store in memory:
an indication that the first product and the second product are the same product; and
for each attribute of a plurality of attributes of the first product: an indication of whether the attribute is the same as a corresponding attribute of the second product;
and wherein for each set of attributes comprising a particular attribute of the first product and a corresponding particular attribute of the second product:
(i) the at least one processor is to instruct transmission of only one attribute from the set of attributes to the merchant device for display when there is stored in the memory an indication that all attributes in the set of attributes are the same; and
(ii) the at least one processor is to instruct transmission of each attribute from the set of attributes to the merchant device for display when there is no indication stored in the memory that all attributes in the set of attributes are the same.

20. The system of claim 13, wherein the at least one processor is to determine that the first product and the second product are a same product by performing operations comprising: comparing a particular attribute of the first product to a corresponding particular attribute of the second product, and determining that the first product and the second product are the same product based on the comparing.

21. The system of claim 20, wherein the at least one processor is to determine that the first product and the second product are the same product based on the particular attribute of the first product being equal to the corresponding particular attribute of the second product.

22. The system of claim 21, wherein the particular attribute of the first product is a stock keeping unit (SKU) of the first product, and wherein the corresponding particular attribute of the second product is a SKU of the second product.

23. The system of claim 13, wherein for each attribute of one or more attributes of the first product, the at least one processor is to: compare the attribute to a corresponding attribute of the second product, and based on the comparing generate or update a score value measuring a likelihood that the first product and the second product are the same product; and wherein the at least one processor is to determine that the first product and the second product are the same product by performing operations including determining that the score value passes a predetermined threshold.

24. The system of claim 23, wherein when the score value passes the predetermined threshold, but is still within a particular range, then the at least one processor is to: instruct transmission of a message to the merchant device, the message querying whether the first product and the second product are the same product; and wherein the at least one processor is to determine that the first product and the second product are the same product by performing operations including: receiving a response to the message, the response originating from the merchant device, and the response confirming that the first product and the second product are the same product.
